(19) United States
(12) Patent Application Publication
(10) Pub. No.: US 2025/0178923 A1
(43) Pub. Date: Jun. 5, 2025

(54) CATHODE ACTIVE MATERIAL AND METHOD FOR PREPARING SAME

(71) Applicant: INDUSTRY-UNIVERSITY COOPERATION FOUNDATION HANYANG UNIVERSITY ERICA CAMPUS, Ansan-si (KR)

(72) Inventors: Jin Ho BANG, Ansan-si (KR); Jin Ha SHIM, Ansan-si (KR)

(21) Appl. No.: 19/034,335

(22) Filed: Jan. 22, 2025

Related U.S. Application Data
(63) Continuation of application No. PCT/KR2023/013471, filed on Sep. 8, 2023.

(30) Foreign Application Priority Data
Sep. 23, 2022 (KR) 10-2022-0120457
Sep. 1, 2023 (KR) 10-2023-0116017

(51) Int. Cl. C01G 53/05

(52) U.S. Cl. CPC C01G 53/05; C01P 2002/74; C01P 2002/82; C01P 2002/85; C01P 2002/88; C01P 2004/03; C01P 2004/84; C01P 2006/40

(57) ABSTRACT

A method for preparing a cathode active material comprises the steps of: preparing a precursor solution, a chelating agent, and a pH adjuster, introducing the precursor solution, the chelating agent, and the pH adjuster into a reactor to prepare a preliminary cathode active material precursor, and oxidizing the surface of the preliminary cathode active material precursor to prepare a cathode active material precursor.

### CROSS-REFERENCE TO RELATED APPLICATION

This application is a bypass continuation of pending PCT International Application No. PCT/KR2023/013471, which was filed on Sep. 8, 2023, and which claims priority to and the benefit of Korean Patent Application No. 10-2022-0120457, which was filed in the Korean Intellectual Property Office on Sep. 23, 2022, and Korean Patent Application No. 10-2023-0116017, which was filed in the Korean Intellectual Property Office on Sep. 1, 2022 the disclosure of which are incorporated herein by reference in its entirety.

### TECHNICAL FIELD

The present invention relates to a cathode active material and a method for preparing the same, and more particularly, to a cathode active material including a core having a relatively high concentration of nickel and a shell having a relatively high concentration of manganese among the nickel and the manganese, and a method for preparing the same.

### BACKGROUND ART

A cathode active material refers to an active material that is present in a cathode material of a secondary battery to electrochemically produce electrical energy.

The cathode active material that is present in the cathode material has lithium ions in an initial state, and serves to provide the lithium ions to an anode in a charge process of the secondary battery.

Accordingly, the cathode active material is utilized in various industries such as lithium metal batteries, lithium air batteries, and lithium ion polymer batteries.

As application fields increase, various cathode active materials are being studied. For example, Korean Patent Registration No. 10-0815583 discloses a method for preparing a cathode active material for a lithium secondary battery, the method including: preparing a coprecipitation compound by mixing an aqueous metal salt solution containing a first metal including nickel, cobalt, and manganese, and optionally a second metal, a chelating agent, and an aqueous basic solution; preparing an active material precursor by drying or heat-treating the coprecipitation compound; and preparing lithium composite metal oxide by mixing and calcining the active material precursor and lithium salt, wherein the lithium composite metal oxide has a layered structure.

### DISCLOSURE

### Technical Problem

One technical object of the present invention is to provide a cathode active material capable of improving rate capability of a secondary battery.

Another technical object of the present invention is to provide a cathode active material capable of improving stability for long-term charge/discharge cycles of a secondary battery.

Still another technical object of the present invention is to provide a method for preparing a cathode active material, capable of improving structural stability.

Yet another technical object of the present invention is to provide a method for preparing a cathode active material, capable of reducing a preparation process cost.

Still yet another technical object of the present invention is to provide a method for preparing a cathode active material, capable of shortening a preparation time.

Another technical object of the present invention is to provide a method for preparing a cathode active material, capable of facilitating mass production.

Technical objects of the present invention are not limited to the technical objects described above.

### Technical Solution

To achieve the objects described above, according to the present invention, there is provided a method for preparing a cathode active material.

According to one embodiment, the method for preparing the cathode active material includes: preparing a precursor solution, a chelating agent, and a pH adjuster, preparing a preliminary cathode active material precursor by introducing the precursor solution, the chelating agent, and the pH adjuster into a reactor; and preparing a cathode active material precursor by oxidizing a surface of the preliminary cathode active material precursor.

According to one embodiment, the precursor solution may include a core precursor solution including a first transition metal, and a shell precursor solution including the first transition metal and a second transition metal.

According to one embodiment, the preparing of the preliminary cathode active material precursor may include: preparing a core by introducing the core precursor solution into the reactor and coprecipitating the core precursor solution; and preparing the preliminary cathode active material precursor including a shell surrounding the core by introducing the shell precursor solution in the core into the reactor and coprecipitating the shell precursor solution.

According to one embodiment, the preparing of the cathode active material precursor by oxidizing the surface of the preliminary cathode active material precursor may include: introducing the preliminary cathode active material precursor into a convection oven, and oxidizing the surface of the preliminary cathode active material precursor by using convection of air generated in the convection oven.

According to one embodiment, the preliminary cathode active material precursor may include hydroxide including the first transition metal and the second transition metal, and the cathode active material precursor obtained by oxidizing the surface of the preliminary cathode active material precursor may include oxyhydroxide including the first transition metal and the second transition metal.

According to one embodiment, the first transition metal may include Ni, the second transition metal may include Mn, the preliminary cathode active material precursor may include NiMn(OH)₂, and the cathode active material precursor may include NiMnOOH.

According to one embodiment, the preparing of the cathode active material precursor by oxidizing the surface of the preliminary cathode active material precursor may include: increasing an oxidation number of Mn on the surface of the preliminary cathode active material precursor to +2 or more, or to +4.

According to one embodiment, Mn having an oxidation number of +2 may be provided on the surface of the preliminary cathode active material precursor, and Mn having an oxidation number of +4 may be provided on a surface of the cathode active material precursor.

According to one embodiment, the cathode active material precursor may include a core and a shell surrounding the core, in which a concentration of Ni may be higher than a concentration of Mn in the core, and a concentration of Mn may be higher than a concentration of Ni in the shell, and

According to one embodiment, the preparing of the cathode active material by heat-treating the cathode active material precursor may include: preventing Mn of the shell from being diffused into the core by Mn⁴⁺ of the shell of the cathode active material precursor.

To achieve the objects described above, according to the present invention, there is provided a cathode active material precursor prepared by the preparing method described above.

According to one embodiment, the cathode active material precursor includes a core and a shell surrounding the core, wherein a concentration of a first transition metal is higher than a concentration of a second transition metal in the core, a concentration of the second transition metal is higher than a concentration of the first transition metal in the shell, and the shell includes oxyhydroxide including the first transition metal and the second transition metal.

According to one embodiment, the first transition metal may include Ni, the second transition metal may include Mn, and Mn⁴⁺ may be observed at 595 cm⁻¹ when the cathode active material precursor is analyzed by Raman spectroscopy.

According to one embodiment, when XPS analysis is performed on the cathode active material precursor, a proportion of Mn⁴⁺ may be increased in a Mn 2P spectrum.

According to one embodiment, the proportion of Mn⁴⁺ of the cathode active material precursor may be 25%.

To achieve the objects described above, according to the present invention, there is provided a cathode active material prepared by the preparing method described above.

According to one embodiment, the cathode active material includes secondary particles obtained by allowing a plurality of primary particles to agglomerate, wherein the cathode active material includes a transition metal layer and a lithium layer, which are alternately and repeatedly stacked, and Ni²⁺ is mixed in the lithium layer, in which a proportion of Ni²⁺ in the lithium layer exceeds 2.1% when XRD analysis is performed.

According to one embodiment, when XRD measurement is performed on the cathode active material, I₀₀₃/I₁₀₄, which is a proportion of a peak value I₀₀₃ corresponding to a (003) plane to a peak value I₁₀₄ corresponding to a (104) plane, may be 1.32.

According to one embodiment, when XPS analysis is performed on the cathode active material, Ni²⁺/(Ni²⁺+Ni³⁺), which is a peak devolution value of Ni³⁺ corresponding to a peak generated at 855.1 eV and Ni²⁺ corresponding to a peak generated at 853.8 eV, may be 19.7%.

### Advantageous Effects

According to the present invention, a method for preparing a cathode active material may include: preparing a precursor solution, a chelating agent, and a pH adjuster, preparing a preliminary cathode active material precursor by introducing the precursor solution, the chelating agent, and the pH adjuster into a reactor; and preparing a cathode active material precursor by oxidizing a surface of the preliminary cathode active material precursor.

The precursor solution may include a core precursor solution including a first transition metal (e.g., Ni), and a shell precursor solution including the first transition metal (e.g., Ni) and a second transition metal (e.g., Mn).

In addition, the preparing of the cathode active material precursor by oxidizing the surface of the preliminary cathode active material precursor may include: introducing the preliminary cathode active material precursor into a convection oven, and oxidizing the surface of the preliminary cathode active material precursor by using convection of air generated in the convection oven.

Accordingly, the prepared cathode active material precursor may include: a core in which a concentration of the first transition metal (e.g., Ni) is higher than a concentration of the second transition metal (e.g., Mn); and a shell surrounding the core, in which a concentration of the second transition metal (e.g., Mn) is higher than a concentration of the first transition metal (e.g., Ni). In addition, the cathode active material precursor may be configured such that the second transition metal having an oxidation number of +4 (e.g., Mn⁴⁺) may be provided on a surface of the shell of the cathode active material precursor.

Accordingly, in a process of preparing the cathode active material by providing a lithium precursor to the cathode active material precursor and performing a heat treatment, the second transition metal (e.g., Mn) of the shell may be prevented from being diffused into the core of the cathode active material precursor by the second transition metal having an oxidation number of +4 (e.g., Mn⁴⁺) on the surface of the shell of the cathode active material precursor.

Accordingly, a structure of the core and the shell of the cathode active material precursor may be maintained in the prepared cathode active material, so that the prepared cathode active material may include: a core in which a concentration of the first transition metal (e.g., Ni) is higher than a concentration of the second transition metal (e.g., Mn); and a shell surrounding the core, in which a concentration of the second transition metal (e.g., Mn) is higher than a concentration of the first transition metal (e.g., Ni). Accordingly, when the cathode active material and an electrolyte make contact with each other, the cathode active material can be protected from the electrolyte by the shell of the cathode active material. Accordingly, when the cathode active material is applied to a cathode of a secondary battery, during charge/discharge cycles of the secondary battery, a side reaction can be minimized at an interface between the cathode and the electrolyte, so that rate capability of the secondary battery can be improved.

In addition, the cathode active material may include: a transition metal layer including the first transition metal (e.g., Ni) and the second transition metal (e.g., Mn); and a lithium layer. A cation (e.g., Ni²⁺) of the first transition metal (e.g., Ni) of the transition metal layer may be mixed in the lithium layer. Accordingly, structural stability of the cathode active material can be improved. Accordingly, when the cathode active material is applied to the cathode of the secondary battery, stability for long-term charge/discharge cycles of the secondary battery can be improved.

### DESCRIPTION OF DRAWINGS

FIG. 1 is a flowchart for describing a method for preparing a cathode active material according to an embodiment of the present invention.

FIG. 2 is a view for describing a first transition metal solution, a second transition metal solution, a chelating agent, and a pH adjuster according to the embodiment of the present invention.

FIG. 3 is a view for describing a method for preparing a core of a preliminary cathode active material precursor according to the embodiment of the present invention.

FIG. 4 is a view for describing a method for preparing a shell precursor solution for forming a shell of the preliminary cathode active material precursor according to the embodiment of the present invention.

FIG. 5 is a view for describing a method for preparing the preliminary cathode active material precursor according to the embodiment of the present invention.

FIG. 6 is a view for describing a method for preparing a cathode active material precursor according to the embodiment of the present invention.

FIG. 7 is a view for describing a core-shell structure of the cathode active material precursor according to the embodiment of the present invention.

FIG. 8 is a view for describing a method for preparing the cathode active material according to the embodiment of the present invention.

FIG. 9 is a view for describing a core-shell structure of the cathode active material according to the embodiment of the present invention.

FIG. 10 is a view for describing a transition metal layer and a lithium layer in the cathode active material according to the embodiment of the present invention.

FIG. 11A is a picture for describing structures of a cathode active material precursor and a cathode active material prepared according to Experimental Example 1 in a method for preparing a cathode active material according to Experimental Example 1 of the present invention.

FIG. 11B is a picture for describing structures of a cathode active material precursor and a cathode active material prepared according to Experimental Example 2 in a method for preparing a cathode active material according to Experimental Example 2 of the present invention.

FIG. 12 is SEM photographs and EDS line graphs of the cathode active material precursors and the cathode active materials according to Experimental Example 1 and Experimental Example 2 of the present invention.

FIG. 13 is SEM photographs and an EDS line graph of a cathode active material according to Experimental Example 3 of the present invention.

FIGS. 14 to 17 are graphs for comparing chemical states of the cathode active material precursors according to Experimental Example 1 and Experimental Example 2 of the present invention.

FIGS. 18 and 19 are graphs for comparing crystal structures and surface characteristics of the cathode active materials according to Experimental Example 1 and Experimental Example 2 of the present invention.

FIG. 20 is graphs for comparing activation energy in heat treatment processes of the cathode active material precursors according to Experimental Example 1 and Experimental Example 2 of the present invention.

FIG. 21 is a graph for comparing derivation weight curves in the heat treatment processes of the cathode active material precursors according to Experimental Example 1 and Experimental Example 2 of the present invention.

FIG. 22 is a graph for comparing DTA curves in heat treatment processes of the cathode active material precursors according to Experimental Example 1 to Experimental Example 3 of the present invention, and sections of the cathode active materials according to Experimental Example 1 to Experimental Example 3 generated after heat treatments have been performed.

FIG. 23 is graphs for comparing performance of half-cells and full-cells to which the cathode active materials according to Experimental Example 1 to Experimental Example 3 of the present invention are applied.

FIG. 24 is graphs for comparing differential capacities (dQ/dV) of the half-cells to which the cathode active materials according to Experimental Example 1 and Experimental Example 2 of the present invention are applied.

FIG. 25 is a graph obtained by measuring a differential capacity (dQ/dV) of the half-cell to which the cathode active material according to Experimental Example 3 of the present invention is applied.

FIG. 26 is graphs for comparing diffusion coefficients of lithium ions in charge/discharge processes of the half-cells to which the cathode active materials according to Experimental Example 1 and Experimental Example 2 of the present invention are applied.

FIG. 27 is graphs for comparing resistance values of the half-cells to which the cathode active materials according to Experimental Example 1 and Experimental Example 2 of the present invention are applied.

FIG. 28 is graphs for comparing crystal structures of the half-cells to which the cathode active materials according to Experimental Example 1 and Experimental Example 2 of the present invention are applied before/after charge/discharge cycles.

FIGS. 29 and 30 are graphs for comparing amounts of by-products of the half-cells to which the cathode active materials according to Experimental Example 1 and Experimental Example 2 of the present invention are applied, which are generated after the charge/discharge cycles.

FIG. 31 is a graph obtained by analyzing chemical compositions of the cathode active material precursor and the cathode active material according to Experimental Example 2 of the present invention.

FIG. 32 is an actual photograph of the cathode active material precursors according to Experimental Example 1 and Experimental Example 2 of the present invention.

FIG. 33 is graphs for comparing surface areas and pore sizes of the cathode active materials according to Experimental Example 1 and Experimental Example 2 of the present invention.

### MODE FOR INVENTION

Hereinafter, exemplary embodiments of the present invention will be described in detail with reference to the accompanying drawings. However, the technical idea of the present invention is not limited to the embodiments described herein, but may be embodied in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, thicknesses of films and regions are exaggerated for effective description of the technical contents.

In addition, although the terms such as first, second, and third have been used to describe various elements in various embodiments of the present disclosure, the elements are not limited by the terms. The terms are used only to distinguish one element from another element. Therefore, an element mentioned as a first element in one embodiment may be mentioned as a second element in another embodiment. The embodiments described and illustrated herein include their complementary embodiments, respectively. Further, the term “and/or” used in the present disclosure is used to include at least one of the elements enumerated before and after the term.

As used herein, an expression in a singular form includes a meaning of a plural form unless the context clearly indicates otherwise. Further, the terms such as “including” and “having” are intended to designate the presence of features, numbers, steps, elements, or combinations thereof described herein, and shall not be construed to preclude any possibility of the presence or addition of one or more other features, numbers, steps, elements, or combinations thereof. In addition, the term “connection” used herein is used to include both indirect and direct connections of a plurality of elements.

Further, in the following description of the present invention, detailed descriptions of known functions or configurations incorporated herein will be omitted when they may make the gist of the present invention unnecessarily unclear.

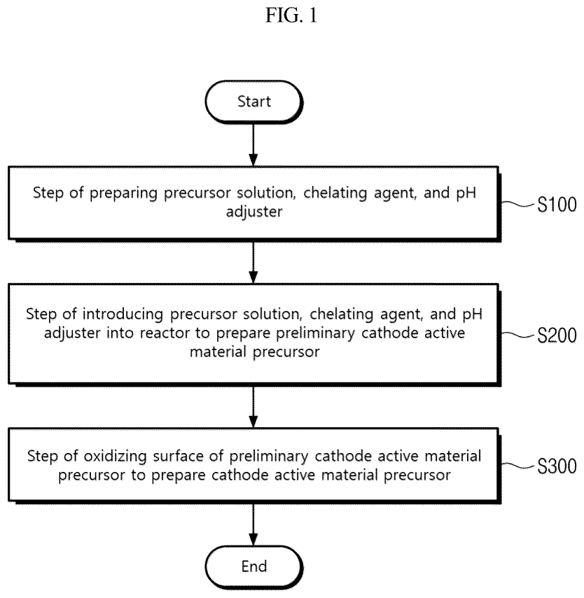

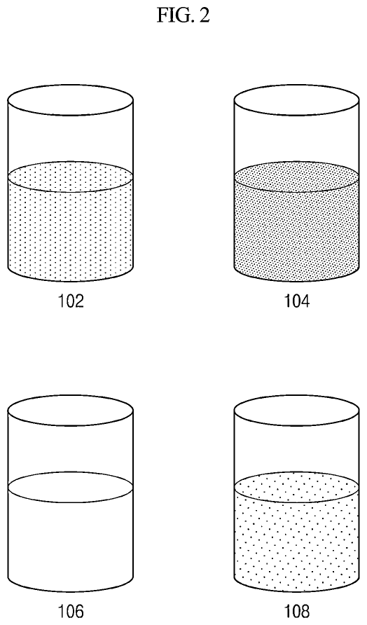

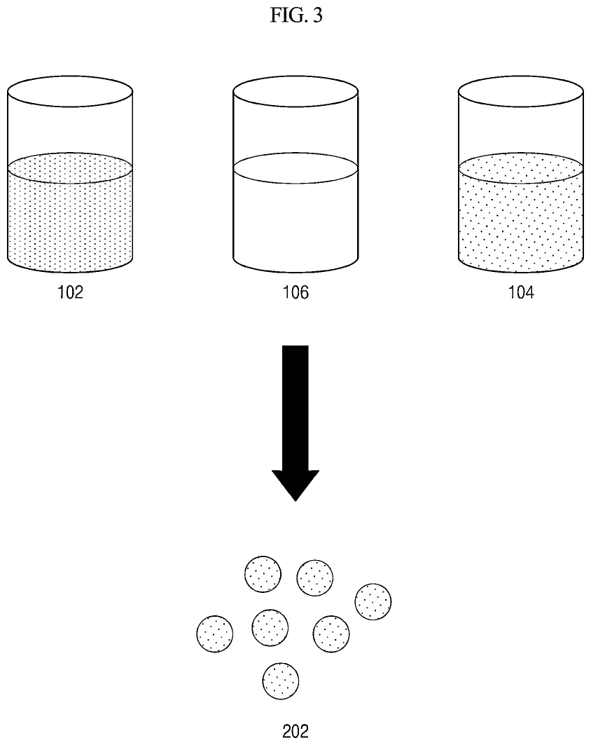

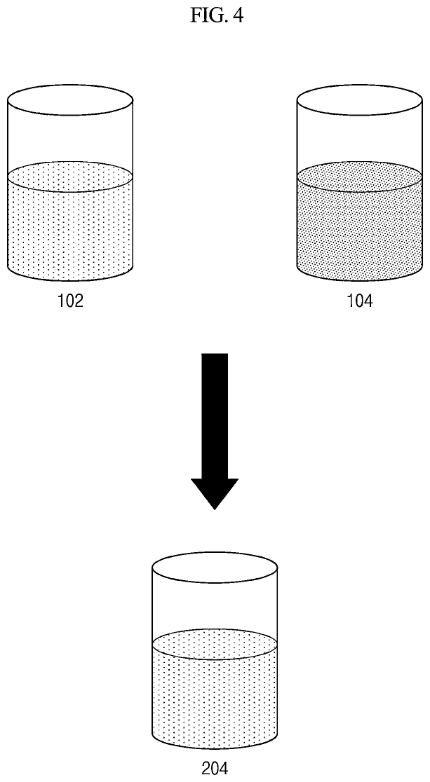

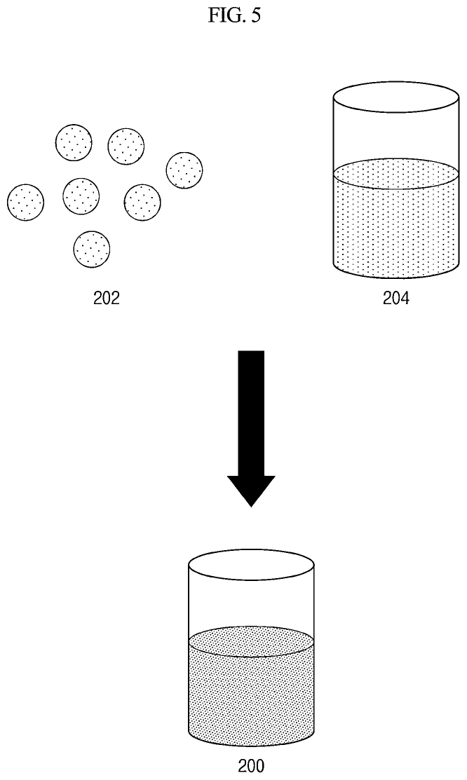

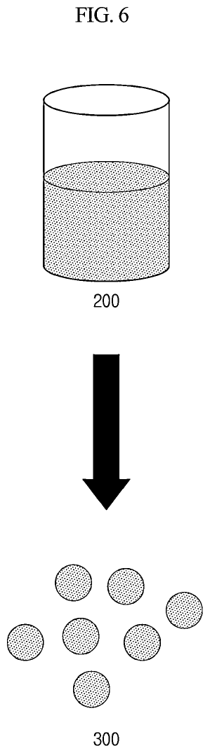

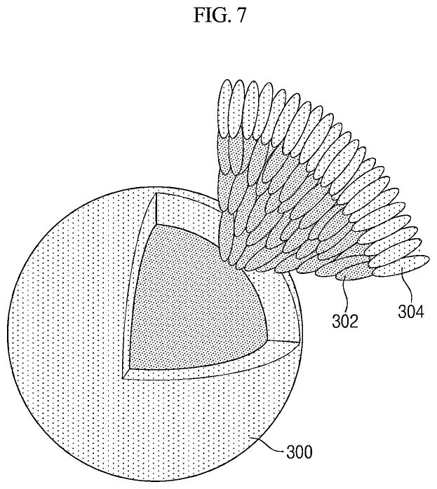

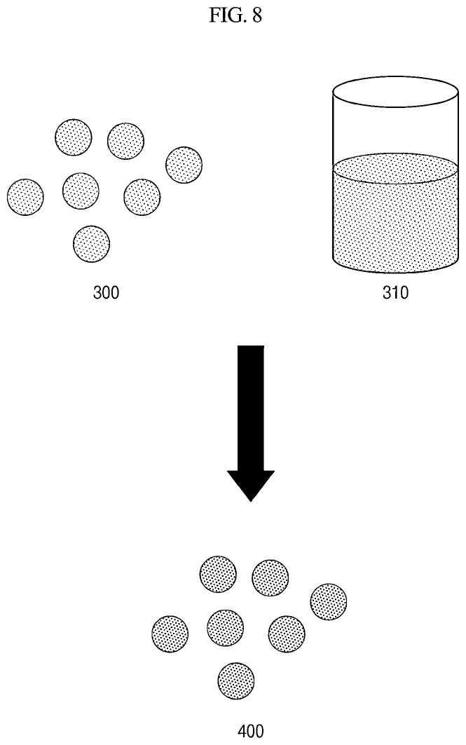

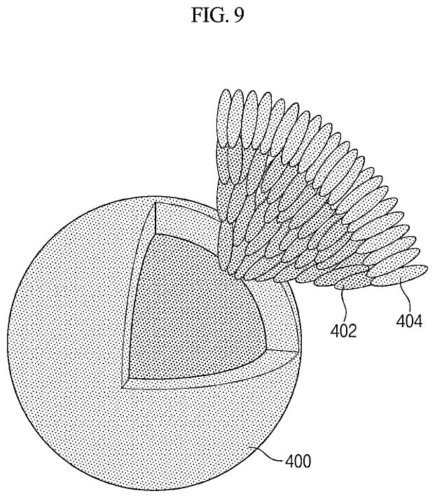

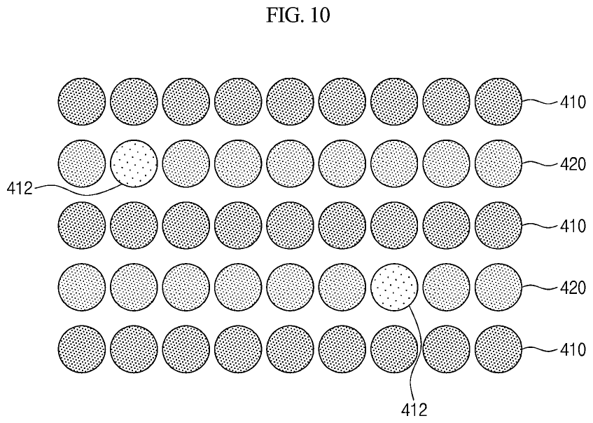

FIG. 1 is a flowchart for describing a method for preparing a cathode active material according to an embodiment of the present invention, FIG. 2 is a view for describing a first transition metal solution, a second transition metal solution, a chelating agent, and a pH adjuster according to the embodiment of the present invention, FIG. 3 is a view for describing a method for preparing a core of a preliminary cathode active material precursor according to the embodiment of the present invention, FIG. 4 is a view for describing a method for preparing a shell precursor solution for forming a shell of the preliminary cathode active material precursor according to the embodiment of the present invention, FIG. 5 is a view for describing a method for preparing the preliminary cathode active material precursor according to the embodiment of the present invention, FIG. 6 is a view for describing a method for preparing a cathode active material precursor according to the embodiment of the present invention, FIG. 7 is a view for describing a core-shell structure of the cathode active material precursor according to the embodiment of the present invention, FIG. 8 is a view for describing a method for preparing the cathode active material according to the embodiment of the present invention, FIG. 9 is a view for describing a core-shell structure of the cathode active material according to the embodiment of the present invention, and FIG. 10 is a view for describing a transition metal layer and a lithium layer in the cathode active material according to the embodiment of the present invention.

Referring to FIGS. 1 and 2, a precursor solution, a chelating agent 106, and a pH adjuster 108 may be prepared (S100).

The precursor solution may include: a core precursor solution including a first transition metal; and a shell precursor solution 204 including the first transition metal and a second transition metal. A core 202 and a shell of a preliminary cathode active material precursor 200 that will be described below may be formed by using the core precursor solution and the shell precursor solution 204.

In detail, the core precursor solution may be a first transition metal solution 102 including the first transition metal. In addition, the shell precursor solution 204 may be a transition metal mixture solution in which the first transition metal solution 102 including the first transition metal and a second transition metal solution 104 including the second transition metal are mixed. For example, mole proportions of the first transition metal solution 102 and the second transition metal solution 104 may be equal to each other. For example, a weight proportion of the first transition metal solution 102 may be higher than a weight proportion of the second transition metal solution 104 in the shell precursor solution 204. For a specific example, a weight ratio of the first transition metal solution 102 to the second transition metal solution 104 in the shell precursor solution 204 may be 4:1. For example, the first transition metal may be Ni. For example, the second transition metal may be Mn.

Referring to FIGS. 1 to 5, the preliminary cathode active material precursor 200 may be prepared by introducing the precursor solution, the chelating agent 106, and the pH adjuster 108 into a reactor (S200).

The preparing of the preliminary cathode active material precursor 200 may include: preparing the core 202 by introducing the core precursor solution into the reactor and coprecipitating the core precursor solution; and preparing the preliminary cathode active material precursor 200 including the shell surrounding the core 202 by introducing the shell precursor solution 204 in the core 202 into the reactor and coprecipitating the shell precursor solution 204.

According to one embodiment, in the preparing of the core 202 by introducing the core precursor solution into the reactor and coprecipitating the core precursor solution, the core 202 may be prepared by introducing the core precursor solution (e.g., 102), the chelating agent 106, and the pH adjuster 108 into the reactor, and coprecipitating a resulting solution at a first temperature for a first time. For a specific example, the first transition metal solution 102, which is the core precursor solution, may be NiSO₄·6H₂O. For example, the first temperature may be 45.5° C. For example, the first time may be 20 hours. For example, the chelating agent 106 may be ammonia water. For example, the pH adjuster 108 may be sodium hydroxide.

In addition, in the preparing of the preliminary cathode active material precursor 200 including the shell surrounding the core 202 by introducing the shell precursor solution 204 in the core 202 into the reactor and coprecipitating the shell precursor solution 204, the preliminary cathode active material precursor 200 including the shell surrounding the core 202 may be prepared by introducing the shell precursor solution 204 in the core 202 and coprecipitating the shell precursor solution 204 at the first temperature for a second time that is shorter than the first time. For a specific example, the first transition metal solution 102 of the shell precursor solution 204 may be NiSO₄·6H₂O, and the second transition metal solution 104 may be MnSO₄·H₂O. For example, the second time may be 4 hours.

Accordingly, the preliminary cathode active material precursor 200 including hydroxide including the first transition metal and the second transition metal may be prepared. For a specific example, the hydroxide including the first transition metal and the second transition metal may be NiMn(OH)₂. In addition, the preliminary cathode active material precursor 200 may include: the core 202 in which a concentration of the first transition metal is higher than a concentration of the second transition metal; and the shell surrounding the core 202, in which a concentration of the second transition metal is higher than a concentration of the first transition metal. Therefore, Mn having an oxidation number of +2 (Mn²⁺) may be provided on a surface of the shell of the preliminary cathode active material precursor 200 due to the coprecipitation of the shell precursor solution 204.

Referring to FIGS. 1 and 6, a cathode active material precursor 300 may be prepared by oxidizing a surface of the preliminary cathode active material precursor 200 (S300).

The preparing of the cathode active material precursor 300 by oxidizing the surface of the preliminary cathode active material precursor 200 may include: introducing the preliminary cathode active material precursor 200 into a convection oven, and oxidizing the surface of the preliminary cathode active material precursor 200 by using convection of air generated in the convection oven. For example, a temperature of the convection oven may be 60° C. For example, an oxidation time of the preliminary cathode active material precursor 200 may be 24 hours. Accordingly, the surface of the preliminary cathode active material precursor 200 may be oxidized, so that oxyhydroxide including the first transition metal and the second transition metal may be provided on a surface of the cathode active material precursor 300. For example, the oxyhydroxide including the first transition metal and the second transition metal may be NiMnOOH.

In addition, the preparing of the cathode active material precursor 300 by oxidizing the surface of the preliminary cathode active material precursor 200 may include: increasing an oxidation number of Mn on the surface of the shell of the preliminary cathode active material precursor 200 to +2 or more, or to +4. As described above, the preliminary cathode active material precursor 200 may be introduced into the convection oven, and the surface of the shell of the preliminary cathode active material precursor 200 may be oxidized by using the convection of air generated in the convection oven. Accordingly, the oxidation number of Mn having the oxidation number of +2 (Mn²⁺) and provided on the surface of the shell of the preliminary cathode active material precursor 200 may be partially increased, so that Mn having an oxidation number of +4 (Mn⁴⁺) may be provided on a surface of a shell 304 of the cathode active material precursor 300 corresponding to the shell of the preliminary cathode active material precursor 200. Accordingly, Mn having the oxidation number of +2 (Mn²⁺) and Mn having the oxidation number of +4 (Mn⁴⁺) may be provided on the surface of the shell 304 of the cathode active material precursor 300. Mn⁴⁺ provided on the surface of the shell 304 of the cathode active material precursor 300 may be observed at 595 cm⁻¹ when the cathode active material precursor 300 is analyzed by Raman spectroscopy. In addition, an increase in a proportion of Mn⁴⁺ provided on the surface of the shell 304 of the cathode active material precursor 300 may be observed when XPS analysis is performed on the cathode active material precursor 300 by a Mn 2P spectrum. For a specific example, the proportion of Mn⁴⁺ on the surface of the shell 304 of the cathode active material precursor 300 may be 25%.

Referring to FIG. 7, a core (302)-shell (304) structure of the cathode active material precursor 300 including secondary particles by allowing a plurality of primary particles to agglomerate will be described.

As shown in FIG. 7, the cathode active material precursor 300 may include: a core 302 corresponding to the core 202 of the preliminary cathode active material precursor 200; and a shell 304 surrounding the core 302 and corresponding to the shell of the preliminary cathode active material precursor 200. Accordingly, the core 302 of the cathode active material precursor 300 may be configured such that a concentration of the first transition metal may be higher than a concentration of the second transition metal, and the shell 304 of the cathode active material precursor 300 may be configured such that a concentration of the second transition metal may be higher than a concentration of the first transition metal.

Referring to FIG. 8, a cathode active material 400 may be prepared by providing a lithium precursor 310 to the cathode active material precursor 300 and performing a heat treatment.

The preparing of the cathode active material 400 may include: preparing a cathode active material source by mixing the cathode active material precursor 300 and the lithium precursor 310; primarily heat-treating the cathode active material source; and secondarily heat-treating the cathode active material source that has been primarily heat-treated. For example, the lithium precursor 310 may be LiOH·H₂O.

According to one embodiment, in the primarily heat-treating of the cathode active material source, for example, a primary heat treatment temperature may be 500° C. For example, a primary heat treatment time may be 5 hours. In addition, in the secondarily heat-treating of the cathode active material source that has been primarily heat-treated, for example, a secondary heat treatment temperature may be 700° C. For example, a secondary heat treatment time may be 10 hours. In a process of heat-treating the cathode active material source, due to Mn⁴⁺ on the surface of the shell 304 of the cathode active material precursor 300 within the cathode active material source, the second transition metal of the shell 304 of the cathode active material precursor 300 may be prevented from being diffused into the core 302 of the cathode active material precursor 300. Accordingly, the structure of the core 302, in which the concentration of the first transition metal is higher than the concentration of the second transition metal, and the shell 304 surrounding the core 302, in which the concentration of the second transition metal is higher than the concentration of the first transition metal, of the cathode active material precursor 300 may be maintained, so that the cathode active material 400 including a core 402 corresponding to the core 302 of the cathode active material precursor 300 and a shell 404 corresponding to the shell 304 of the cathode active material precursor 300 may be prepared.

In summary, according to the method for preparing the cathode active material 400, due to the preparing of the cathode active material precursor 300 by oxidizing the surface of the preliminary cathode active material precursor 200, in the preparing of the cathode active material 400 by providing the lithium precursor 310 to the cathode active material precursor 300 and performing the heat treatment, the structure of the core 302 and the shell 304 of the cathode active material precursor 300 may be maintained, so that the cathode active material 400 including the core 402 and the shell 404 may be prepared. Accordingly, when compared with a conventional method for preparing the cathode active material 400 including the core 402 and the shell 404 (e.g., metal doping, or temperature control of a heat treatment of a cathode active material precursor), a process of preparing the cathode active material 400 may be simplified, so that a preparation time of the cathode active material 400 may be shortened. Accordingly, a preparation process cost of the cathode active material 400 may be reduced, so that mass production of the cathode active material 400 may be facilitated.

In conclusion, the method for preparing the cathode active material 400 according to an embodiment of the present disclosure may include: preparing the precursor solution, the chelating agent 106, and the pH adjuster 108; preparing the preliminary cathode active material precursor 200 by introducing the precursor solution, the chelating agent 106, and the pH adjuster 108 into the reactor; and preparing the cathode active material precursor 300 by oxidizing the surface of the preliminary cathode active material precursor 200.

The precursor solution may include: the core precursor solution including the first transition metal (e.g., Ni); and the shell precursor solution 204 including the first transition metal (e.g., Ni) and the second transition metal (e.g., Mn).

In addition, the preparing of the cathode active material precursor 300 by oxidizing the surface of the preliminary cathode active material precursor 200 may include: introducing the preliminary cathode active material precursor 200 into the convection oven, and oxidizing the surface of the preliminary cathode active material precursor 200 by using the convection of air generated in the convection oven.

Accordingly, the prepared cathode active material precursor 300 may include: the core 302 in which the concentration of the first transition metal (e.g., Ni) is higher than the concentration of the second transition metal (e.g., Mn); and the shell 304 surrounding the core 302, in which the concentration of the second transition metal (e.g., Mn) is higher than the concentration of the first transition metal (e.g., Ni). In addition, the cathode active material precursor 300 may be configured such that the second transition metal having an oxidation number of +4 (e.g., Mn⁴⁺) may be provided on the surface of the shell 304 of the cathode active material precursor 300. Accordingly, in the process of preparing the cathode active material 400 by providing the lithium precursor 310 to the cathode active material precursor 300 and performing the heat treatment, the second transition metal (e.g., Mn) of the shell 304 may be prevented from being diffused into the core 302 of the cathode active material precursor 300 by the second transition metal having the oxidation number of +4 (e.g., Mn⁴⁺) on the surface of the shell 304 of the cathode active material precursor 300.

Accordingly, the structure of the core 302 and the shell 304 of the cathode active material precursor 300 may be maintained in the prepared cathode active material 400, so that the prepared cathode active material 400 may include the core 402 corresponding to the core 302 of the cathode active material precursor 300, and the shell 404 corresponding to the shell 304 of the cathode active material precursor 300.

Referring to FIG. 9, a core (402)-shell (404) structure of the cathode active material 400 including secondary particles by allowing a plurality of primary particles to agglomerate will be described.

As shown in FIG. 9, the cathode active material 400 may include: the core 402 corresponding to the core 302 of the cathode active material precursor 300; and the shell 404 surrounding the core 402 and corresponding to the shell 304 of the cathode active material precursor 300. Therefore, the core 402 of the cathode active material 400 may be configured such that a concentration of the first transition metal may be higher than a concentration of the second transition metal, and the shell 404 of the cathode active material 400 may be configured such that a concentration of the second transition metal may be higher than a concentration of the first transition metal. Accordingly, when the cathode active material 400 and an electrolyte make contact with each other, the cathode active material 400 may be protected from the electrolyte by the shell 404 of the cathode active material 400. Accordingly, when the cathode active material 400 is applied to a cathode of a secondary battery, during charge/discharge cycles of the secondary battery, a side reaction may be minimized at an interface between the cathode and the electrolyte, so that rate capability of the secondary battery may be improved.

Referring to FIG. 10, the transition metal layer 410 and the lithium layer 420 in the cathode active material 400 will be described.

As shown in FIG. 10, the cathode active material 400 may include the transition metal layer 410 including the first transition metal and the second transition metal and the lithium layer 420, which are alternately and repeatedly stacked. A cation 412 of the first transition metal of the transition metal layer 410 may be mixed in the lithium layer 420. For a specific example, the cation 412 of the first transition metal may be Ni²⁺.

Ni²⁺ 412 in the lithium layer 420 of the cathode active material 400 may be recognized through XRD analysis. When XRD analysis is performed on the cathode active material, I₀₀₃/I₁₀₄, which is a proportion of a peak value I₀₀₃ corresponding to a (003) plane to a peak value I₁₀₄ corresponding to a (104) plane, may be, for example, 1.32. I₀₀₃/I₁₀₄ may refer to a level at which Ni²⁺ 412 is mixed in the lithium layer 420 of the cathode active material 400. Therefore, Ni²⁺ 412 may be recognized in the lithium layer 420 of the cathode active material 400. In detail, a proportion of Ni²⁺ 412 in the lithium layer 420 of the cathode active material 400 may exceed 2.1%. When Rietveld refinement is performed on a result of the XRD analysis on the cathode active material 400, the proportion of Ni²⁺ 412 in the lithium layer 420 of the cathode active material 400 may be, for example, 3.0%. Accordingly, structural stability of the cathode active material 400 may be improved. Accordingly, when the cathode active material 400 is applied to the cathode of the secondary battery, stability for long-term charge/discharge cycles of the secondary battery may be improved.

In conclusion, the cathode active material 400 according to the embodiment of the present disclosure may include: the core 402 in which the concentration of the first transition metal (e.g., Ni) is higher than the concentration of the second transition metal (e.g., Mn); and the shell 404 surrounding the core 402, in which the concentration of the second transition metal (e.g., Mn) is higher than the concentration of the first transition metal (e.g., Ni). Accordingly, when the cathode active material 400 and an electrolyte make contact with each other, the cathode active material 400 may be protected from the electrolyte by the shell 404 of the cathode active material 400. Accordingly, when the cathode active material 400 is applied to the cathode of the secondary battery, during charge/discharge cycles of the secondary battery, a side reaction may be minimized at the interface between the cathode and the electrolyte, so that rate capability of the secondary battery may be improved.

In addition, the cathode active material 400 may include: the transition metal layer 410 including the first transition metal (e.g., Ni) and the second transition metal (e.g., Mn); and the lithium layer 420. A cation 412 (e.g., Ni²⁺) of the first transition metal (e.g., Ni) of the transition metal layer 410 may be mixed in the lithium layer 420. Accordingly, structural stability of the cathode active material 400 may be improved. Accordingly, when the cathode active material 400 is applied to the cathode of the secondary battery, stability for long-term charge/discharge cycles of the secondary battery may be improved.

Hereinafter, specific experimental examples and characteristic evaluation results of the cathode active material precursor and the cathode active material according to the embodiment of the present invention will be described.

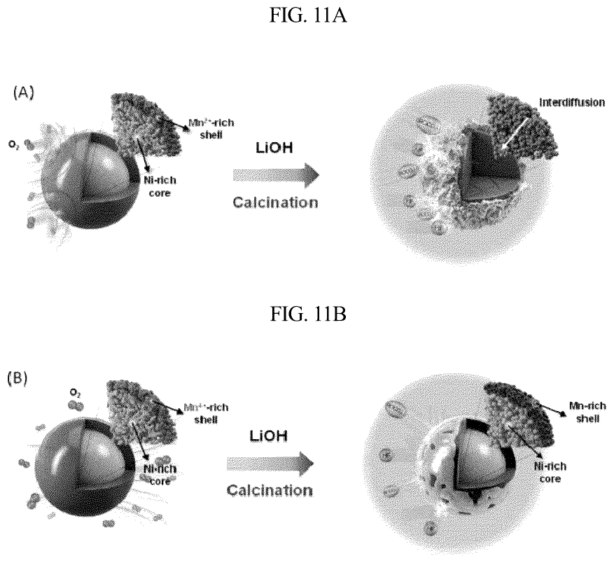

FIG. 11A is a picture for describing structures of a cathode active material precursor and a cathode active material prepared according to Experimental Example 1 in a method for preparing a cathode active material according to Experimental Example 1 of the present invention, and FIG. 11B is a picture for describing structures of a cathode active material precursor and a cathode active material prepared according to Experimental Example 2 in a method for preparing a cathode active material according to Experimental Example 2 of the present invention.

### Cathode Active Material According to Experimental Example 1 (Ex1)

Ni₄·6H₂O (2M) was prepared as a first transition metal solution, MnSO₄·6H₂O (2M) was prepared as a second transition metal solution, NaOH (5M) was prepared as a pH adjuster, and NH₄OH (3M) was prepared as a chelating agent. In addition, the first transition metal solution was used as a core precursor solution, and the first transition metal solution and the second transition metal solution were mixed in a ratio of 8:2 so as to be prepared as a shell precursor solution.

The core precursor solution, the chelating agent, and the pH adjuster were introduced into a coprecipitation reactor and coprecipitated (45.5° C., pH 11.1, 900 rpm, 20 hours), so that a core of a preliminary cathode active material precursor was generated. In addition, the shell precursor solution was introduced in the core into the coprecipitation reactor and coprecipitated (45.5° C., pH 11.1, 900 rpm, 4 hours), so that the preliminary cathode active material precursor including a shell surrounding the core was prepared.

In addition, the preliminary cathode active material precursor was introduced into a vacuum oven, and dried at 60° C. for 24 hours, so that, as shown in FIG. 11A, a cathode active material precursor including a core having a relatively high concentration of nickel and a shell having a relatively high concentration of manganese was prepared.

The cathode active material precursor and LiOHH₂O, which is a lithium source solution, were mixed at a mole ratio of 1.00:1.03, so that a cathode active material source was prepared. In addition, the cathode active material source was introduced into a tube electric furnace, a primary heat treatment was performed under a primary heat treatment condition (oxygen atmosphere, 500° C., 5 hours), and, in a process of performing a secondary heat treatment under a secondary heat treatment condition (oxygen atmosphere, 700° C., 10 hours), manganese of the shell of the cathode active material precursor was diffused into the core of the cathode active material precursor, so that, as shown in FIG. 11A, a cathode active material in which concentration distributions of transition metals (Li, Ni, and Mn) are uniform was prepared.

### Cathode Active Material According to Experimental Example 2 (Ex2)

Except that the preliminary cathode active material precursor was introduced into a convection oven, so that, as shown in FIG. 11B, a cathode active material precursor including a core having a relatively high concentration of nickel and a shell having a relatively high concentration of manganese was prepared, manganese of the shell of the cathode active material precursor was prevented from being diffused into the core of the cathode active material precursor, so that, as shown in FIG. 11B, a cathode active material in which a core-shell structure of the cathode active material precursor is maintained was prepared in the same manner as Experimental Example 1.

### Cathode Active Material According to Experimental Example 3 (Ex3)

Except that a precursor solution (NiSO₄·6H2O (2M): MnSO₄·6H₂O (2M) =97:3) was prepared instead of the core precursor solution and the shell precursor solution, and the precursor solution, the chelating agent, and the pH adjuster were introduced into the coprecipitation reactor and coprecipitated (45.5° C., pH 11.1, 900 rpm, 24 hours), so that a preliminary cathode active material precursor was prepared, a cathode active material was prepared in the same manner as Experimental Example 1.

TABLE 1

| | | | | Drying |
|---|---|---|---|---|
| | | Shell | | method of |
| | | precursor | Precursor | preliminary |
| | Core | solution | solution | cathode |
| | precursor | (NiSO₄6H₂O: | (NiSO₄6H₂O: | active |
| | solution | MnSO₄6H₂O = | MnSO₄6H₂O = | material |
| Classification | (NiSO₄6H₂O) | 8:2) | 97:3) | precursor |
| Experimental | ◯ | ◯ | X | Vacuum |
| Example 1 | | | | oven |
| (ex1) | | | | |
| Experimental | ◯ | ◯ | X | Convection |
| Example 2 | | | | oven |
| (ex2) | | | | |
| Experimental | X | X | ◯ | Vacuum |
| Example 3 | | | | oven |
| (ex3) | | | | |

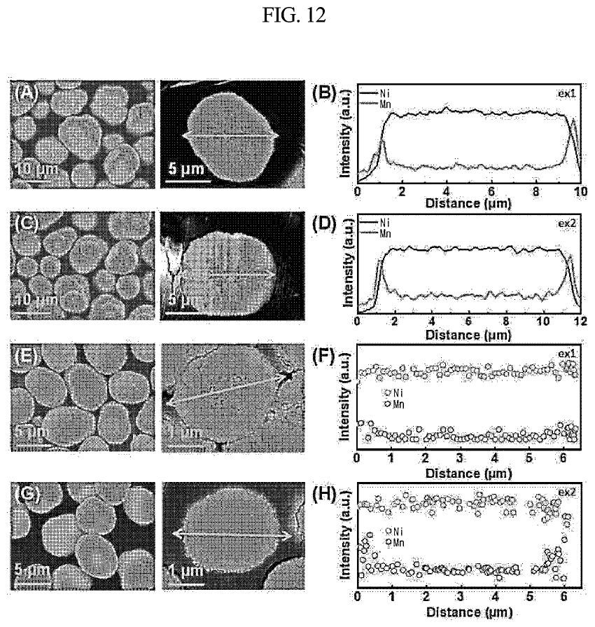

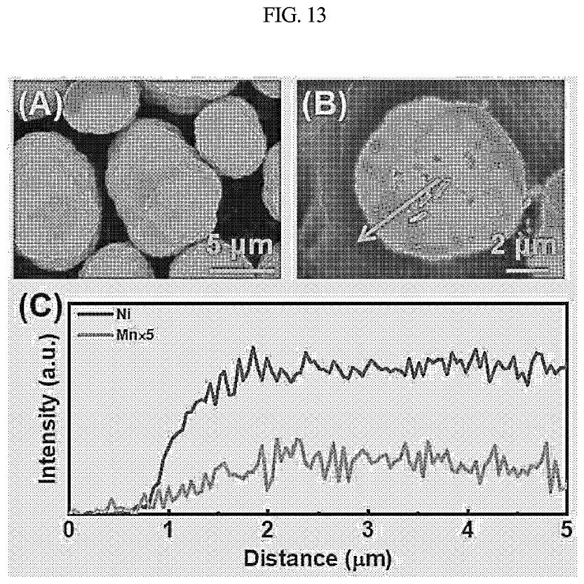

FIG. 12 is SEM photographs and EDS line graphs of the cathode active material precursors and the cathode active materials according to Experimental Example 1 and Experimental Example 2 of the present invention, and FIG. 13 is SEM photographs and an EDS line graph of a cathode active material according to Experimental Example 3 of the present invention.

Referring to (A) of FIG. 12, a cathode active material precursor according to Experimental Example 1 (ex1) was photographed by an SEM. Referring to (B) of FIG. 12, Ni and Mn elements of the cathode active material precursor photographed in (A) of FIG. 12 were analyzed by an EDS linc. Referring to (C) of FIG. 12, a cathode active material precursor according to Experimental Example 2 (ex2) was photographed by an SEM. Referring to (D) of FIG. 12, Ni and Mn elements of the cathode active material precursor photographed in (C) of FIG. 12 were analyzed by an EDS line. Referring to (E) of FIG. 12, a cathode active material according to Experimental Example 1 (ex1) was photographed by an SEM. Referring to (F) of FIG. 12, Ni and Mn elements of the cathode active material photographed in (E) of FIG. 12 were analyzed by an EDS line. Referring to (G) of FIG. 12, a cathode active material according to Experimental Example 2 (ex2) was photographed by an SEM. Referring to (H) of FIG. 12, Ni and Mn elements of the cathode active material photographed in (G) of FIG. 12 were analyzed by an EDS line. Referring to FIGS. (A) of FIG. 13 and (B) of FIG. 13, a cathode active material according to Experimental Example 3 (ex3) was photographed by an SEM. Referring to (C) of FIG. 13, Ni and Mn of the cathode active material photographed in FIG. 13 (B) were analyzed by an EDS line.

As shown in FIGS. (A) of FIG. 12 to (D) of FIG. 12, it may be found that the cathode active material precursors according to Experimental Example 1 (ex1) and Experimental Example 2 (ex2) have a core-shell structure including a core having a relatively high concentration of Ni and a shell surrounding the core and having a relatively high concentration of Mn, and a thickness of a shell of each of the cathode active material precursors according to Experimental Example 1 (ex1) and Experimental Example 2 (ex2) is about 0.88 um.

As shown in FIGS. (E) of FIG. 12 to (F) of FIG. 12, it may be found in the cathode active material according to Experimental Example 1 (ex1) that the core-shell structure of the cathode active material precursor according to Experimental Example 1 (ex1) is not maintained even after a heat treatment. In contrast, it may be found in the cathode active material according to Experimental Example 2 (ex2) that the core-shell structure of the cathode active material precursor according to Experimental Example 2 (ex2) is maintained even after a heat treatment. This factor is interpreted as being due to the fact that, in a heat treatment process of the cathode active material precursor according to Experimental Example 2 (ex2), Mn on a surface (shell) of the cathode active material precursor is prevented from being diffused into an inside (core) of the cathode active material precursor by oxidized Mn on the surface (shell) of the cathode active material precursor.

As shown in FIGS. (A) of FIG. 13 to (C) of FIG. 13, it may be found that the cathode active material according to Experimental Example 3 (ex) does not include a core having a relatively high concentration of Ni and a shell having a relatively high concentration of Mn, and a concentration of Mn on a surface of the cathode active material according to Experimental Example 3 (ex) is lower than a concentration of Mn on a surface of the cathode active material according to Experimental Example 1 (ex1).

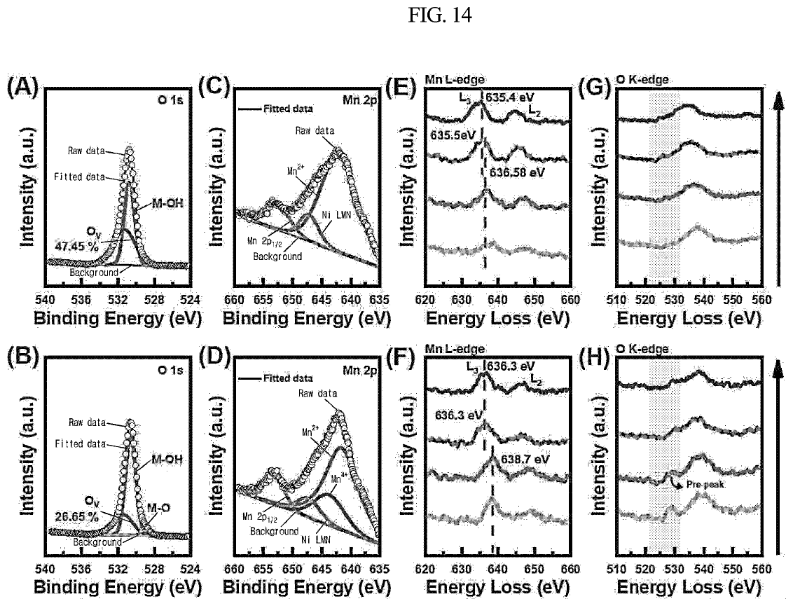

FIGS. 14 to 17 are graphs for comparing chemical states of the cathode active material precursors according to Experimental Example 1 and Experimental Example 2 of the present invention.

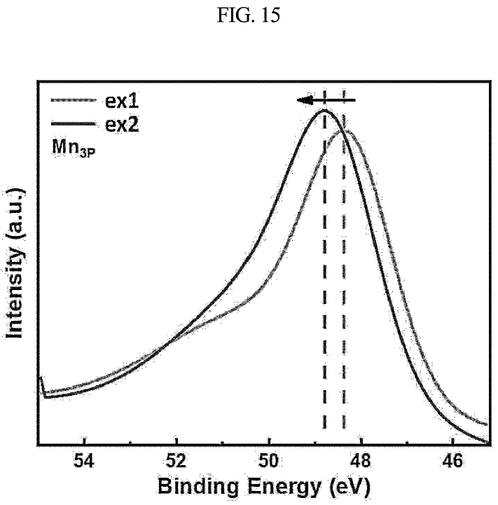

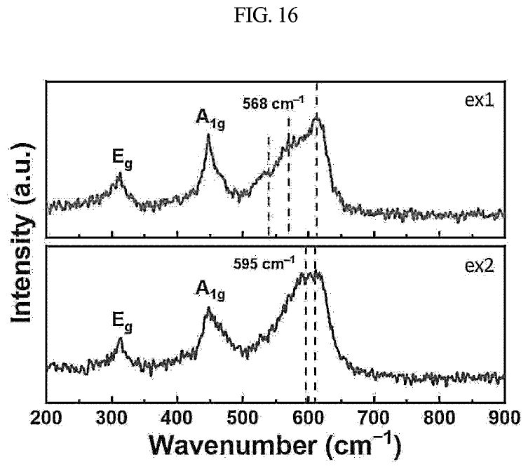

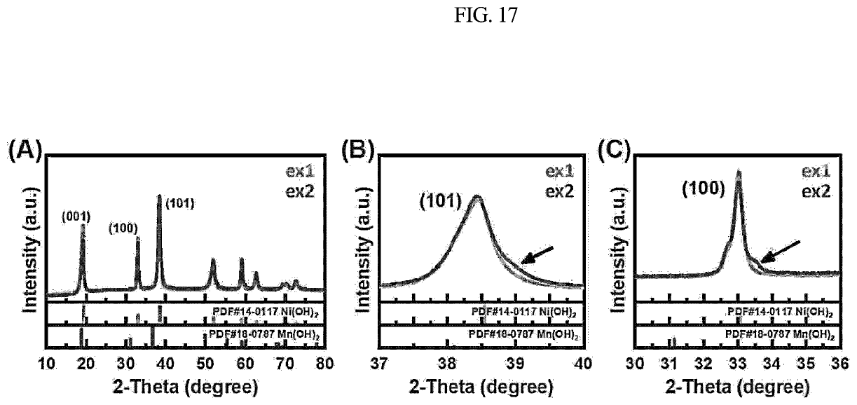

Referring to (A) of FIG. 14, an O 1 s spectrum of the cathode active material precursor according to Experimental Example 1 (ex1) was analyzed by XPS. Referring to (B) of FIG. 14, an O 1 s spectrum of the cathode active material precursor according to Experimental Example 2 (ex2) was analyzed by XPS. Referring to (C) of FIG. 14, a Mn 2p spectrum of the cathode active material precursor according to Experimental Example 1 (ex1) was analyzed by XPS. Referring to (D) of FIG. 14, a Mn 2p spectrum of the cathode active material precursor according to Experimental Example 2 (ex2) was analyzed by XPS. Referring to (E) of FIG. 14, the cathode active material precursor according to Experimental Example 1 (ex1) was analyzed by EELS at a Mn L-edge. Referring to (F) of FIG. 14, the cathode active material precursor according to Experimental Example 2 (ex2) was analyzed by EELS at a Mn L-edge. Referring to (G) of FIG. 14, the cathode active material precursor according to Experimental Example 1 (ex1) was analyzed by EELS at an O K-edge. Referring to (F) of FIG. 14, the cathode active material precursor according to Experimental Example 2 (ex2) was analyzed by EELS at an O K-edge. Referring to FIG. 15, Mn 3p spectra of the cathode active material precursors according to Experimental Example 1 (ex1) and Experimental Example 2 (ex2) were analyzed by XPS. Referring to FIG. 16, the cathode active material precursors according to Experimental Example 1 (ex 1) and Experimental Example 2 (ex2) were analyzed by Raman spectroscopy. Referring to (A) of FIG. 17, the cathode active material precursors according to Experimental Example 1 (ex1) and Experimental Example 2 (ex2) were analyzed by XRD. Referring to (B) of FIG. 17, a peak of a (101) plane was enlarged in the XRD graph analyzed in (A) of FIG. 17. Referring to (C) of FIG. 17, a peak of a (100) plane was enlarged in the XRD graph analyzed in (A) of FIG. 17.

As shown in (A) of FIG. 14 and (B) of FIG. 14, it may be found that the cathode active material precursor according to Experimental Example 1 (ex1) has a metal-hydroxide (530.7 eV) bond and an oxygen vacancy (531.4 eV) of 47.5%. It may be found that the cathode active material precursor according to Experimental Example 2 (ex2) has a metal-oxygen (528.9 eV) bond and an oxygen vacancy (531.4 eV) of 26.7%. The metal-oxygen bond is interpreted as being due to generation of metal oxyhydroxide caused by oxidation and dehydration of metal hydroxide of the preliminary cathode active material precursor according to Experimental Example 2 (ex2) in a process of introducing the preliminary cathode active material precursor according to Experimental Example 2 (ex2) into the convection oven and drying the preliminary cathode active material precursor according to Experimental Example 2 (ex2).

As shown in (A) of FIG. 14 and (D) of FIG. 14, it may be found that the cathode active material precursor according to Experimental Example 1 (ex1) has Mn²⁺ (642.1 eV) on a surface (shell) of the cathode active material precursor according to Experimental Example 1 (ex1). In contrast, it may be found that the cathode active material precursor according to Experimental Example 2 (ex2) has Mn⁴⁺ (646.4 eV) having a concentration of 25.0% as well as Mn²⁺ (642.1 eV) on the surface (shell) of the cathode active material precursor according to Experimental Example 2 (ex2).

As shown in (E) of FIG. 14 and (F) of FIG. 14, it may be found that an energy loss peak (636.8 to 638.7 eV) of the cathode active material precursor according to Experimental Example 2 (ex2) is higher than an energy loss peak (635.4 eV to 636.6 eV) of the cathode active material precursor according to Experimental Example 1 (ex1). Accordingly, it may be found that an oxidation level of a Mn atom on the surface (shell) of the cathode active material precursor according to Experimental Example 2 (ex2) is higher than an oxidation level of a Mn atom on the surface (shell) of the cathode active material precursor according to Experimental Example 1 (ex1).

As shown in (G) of FIG. 14 and (H) of FIG. 14, it may be found that a peak intensity corresponding to an oxygen 2p orbital-metal 3d orbital bond of the cathode active material precursor according to Experimental Example 2 (ex2) is stronger than a peak intensity corresponding to an oxygen 2p orbital-metal 3d orbital bond of the cathode active material precursor according to Experimental Example 1 (ex1). Therefore, it may be found that an intensity of a bond between a Mn atom and an O atom on the surface (shell) of the cathode active material precursor according to Experimental Example 2 (ex2) is stronger than an intensity of a bond between a Mn atom and an O atom on the surface (shell) of the cathode active material precursor according to Experimental Example 1 (ex1). Accordingly, it may be found that the oxidation level of the Mn atom on the surface (shell) of the cathode active material precursor according to Experimental Example 2 (ex2) is higher than the oxidation level of the Mn atom on the surface (shell) of the cathode active material precursor according to Experimental Example 1 (ex1).

As shown in FIG. 15, it may be found that binding energy (48.84 eV) corresponding to a Mn 3p peak of the cathode active material precursor according to Experimental Example 2 (ex2) is higher than binding energy (48.35 eV) corresponding to a Mn 3p peak of the cathode active material precursor according to Experimental Example 1 (ex1). Therefore, it may be found that an oxidation number of the Mn atom on the surface (shell) of the cathode active material precursor according to Experimental Example 2 (ex2) is higher than an oxidation number of the Mn atom on the surface (shell) of the cathode active material precursor according to Experimental Example 1 (ex1).

As shown in FIG. 16, it may be found that Eg (313 cm⁻¹) and Alg (448 cm⁻¹) peaks corresponding to nickel hydroxide are generated in the cathode active material precursors according to Experimental Example 1 (ex1) and Experimental Example 2 (ex2). In addition, it may be found that a hump peak (568 cm⁻¹) associated with a stretching mode of Mn²⁺ is generated in the cathode active material precursor according to Experimental Example 1 (ex1) in wave numbers (500 cm⁻¹ to 700 cm⁻¹) corresponding to the bond between the Mn atom and the O atom. In contrast, it may be found that a peak (595 cm⁻¹) associated with Mn⁴⁺ is generated in the cathode active material precursor according to Experimental Example 2 (ex2). It may be found that the oxidation number of the Mn atom on the surface (shell) of the cathode active material precursor according to Experimental Example 2 (ex2) is higher than the oxidation number of the Mn atom on the surface (shell) of the cathode active material precursor according to Experimental Example 1 (ex1).

As shown in (A) of FIG. 17, it may be found that the cathode active material precursors according to Experimental Example 1 (ex1) and Experimental Example 2 (ex2) have a P3m1 space group structure.

As shown in (B) of FIG. 17 and (C) of FIG. 17, unlike the cathode active material precursor according to Experimental Example 1 (ex), it may be found in the cathode active material precursor according to Experimental Example 2 (ex2) that peaks associated with metal oxyhydroxide are generated on the (101) plane and the (100) plane due to oxidation and dehydration of metal hydroxide of the preliminary cathode active material precursor according to Experimental Example 2 (ex2).

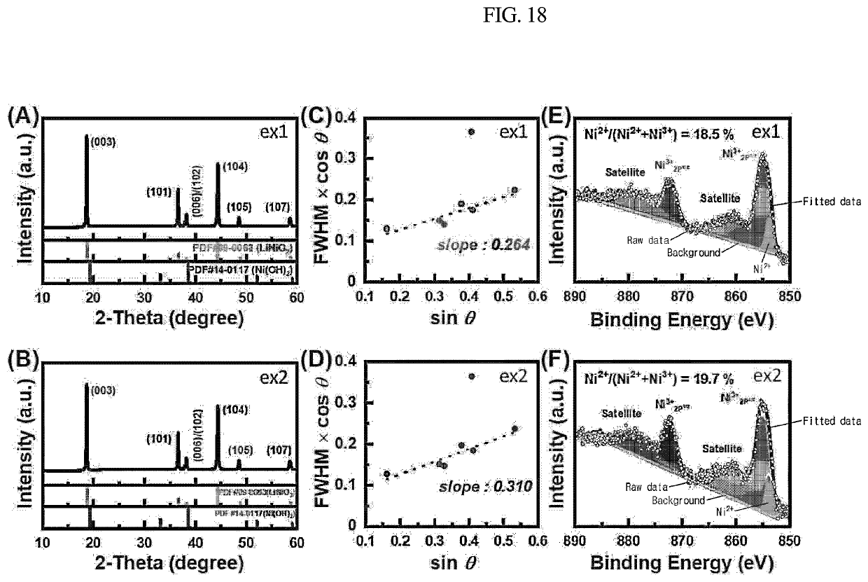

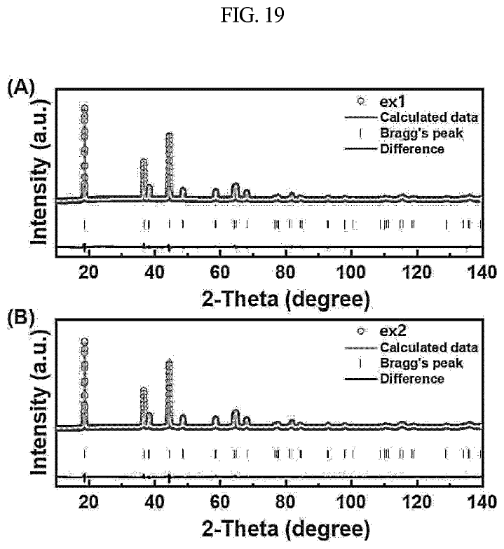

FIGS. 18 and 19 are graphs for comparing crystal structures and surface characteristics of the cathode active materials according to Experimental Example 1 and Experimental Example 2 of the present invention.

Referring to (A) of FIG. 18, the cathode active material according to Experimental Example 1 (ex1) was analyzed by XRD. Referring to (B) of FIG. 18, the cathode active material according to Experimental Example 2 (ex2) was analyzed by XRD. Referring to (C) of FIG. 18, an XRD result analyzed in (A) of FIG. 18 was shown in a W-H plot. Referring to (D) of FIG. 18, an XRD result analyzed in (B) of FIG. 18 was shown in a W-H plot. Referring to (E) of FIG. 18, a Ni 2p spectrum of the cathode active material according to Experimental Example 1 (ex1) was analyzed by XPS. Referring to (F) of FIG. 18, a Ni 2p spectrum of the cathode active material according to Experimental Example 2 (ex2) was analyzed by XPS. Referring to FIG. 19, Rietveld refinement was performed on XRD results analyzed in (A) of FIG. 18 and (B) of FIG. 18.

As shown in (A) of FIG. 18 and (B) of FIG. 18, it may be found that the cathode active materials according to Experimental Example 1 (ex1) and Experimental Example 2 (ex2) have a hexagonal R3m crystal structure that does not include impurities. In addition, it may be found that I₀₀₃/I₁₀₄, which is a proportion of a peak value I₀₀₃ corresponding to a (003) plane to a peak value I₁₀₄ corresponding to a (104) plane, of the cathode active material according to Experimental Example 1 (ex1) is 1.42. In contrast, it may be found that I₀₀₃/I₁₀₄, which is a proportion of a peak value loos corresponding to a (003) plane to a peak value I₁₀₄ corresponding to a (104) plane, of the cathode active material according to Experimental Example 2 (ex2) is 1.32. A I₀₀₃/I₁₀₄ ratio may refer to a level at which Ni²⁺ is mixed in a lithium layer of the cathode active material. Therefore, it may be found that a concentration of Ni²⁺ mixed in the lithium layer of the cathode active material according to Experimental Example 2 (ex2) is higher than a concentration of Ni²⁺ mixed in the lithium layer of the cathode active material according to Experimental Example 1 (ex1). This factor is interpreted as being due to the fact that the core-shell structure of the cathode active material precursor according to Experimental Example 2 (ex2) is maintained even after the heat treatment due to the oxidized Mn on the surface (shell) of the cathode active material precursor according to Experimental Example 2 (ex2).

As shown in (C) of FIG. 18 and (D) of FIG. 18, it may be found that a slope (0.310) of the W-H plot of the cathode active material according to Experimental Example 2 (ex2) is greater than a slope (0.264) of the W-H plot of the cathode active material according to Experimental Example 1 (ex1). This factor is interpreted as being due to the fact that the core-shell structure of the cathode active material precursor according to Experimental Example 2 (ex2) is maintained even after the heat treatment due to the oxidized Mn on the surface (shell) of the cathode active material precursor according to Experimental Example 2 (ex2).

As shown in (E) of FIG. 18 and (F) of FIG. 18, it may be found in the cathode active material according to Experimental Example 1 (ex1) that Ni²⁺/(Ni²⁺+Ni³⁺), which is a peak devolution value of Ni³⁺ corresponding to a peak generated at 855.1 eV and Ni²⁺ corresponding to a peak generated at 853.8 eV, is 18.5%. In addition, it may be found in the cathode active material according to Experimental Example 2 (ex2) that Ni²⁺/(Ni²⁺+Ni³⁺), which is a peak devolution value of Ni³⁺ corresponding to a peak generated at 855.1 eV and Ni²⁺ corresponding to a peak generated at 853.8 eV, is 19.7%. Therefore, it may be predicted that a concentration of Ni²⁺ of the cathode active material according to Experimental Example 2 (ex2) is higher than a concentration (2.1%) of Ni²⁺ of the cathode active material according to Experimental Example 1 (ex1).

As shown in (A) of FIG. 19 and (B) of FIG. 19, it may be found that the concentration (3.0%) of Ni²⁺ of the cathode active material according to Experimental Example 2 (ex2) is higher than the concentration (2.1%) of Ni²⁺ of the cathode active material according to Experimental Example 1 (ex1). Accordingly, it may be found that a pillar effect is increased more in the cathode active material according to Experimental Example 2 (ex2) than in the cathode active material according to Experimental Example 1 (ex1), so that the cathode active material according to Experimental Example 2 (ex2) is structurally more stable than the cathode active material according to Experimental Example 1 (ex1).

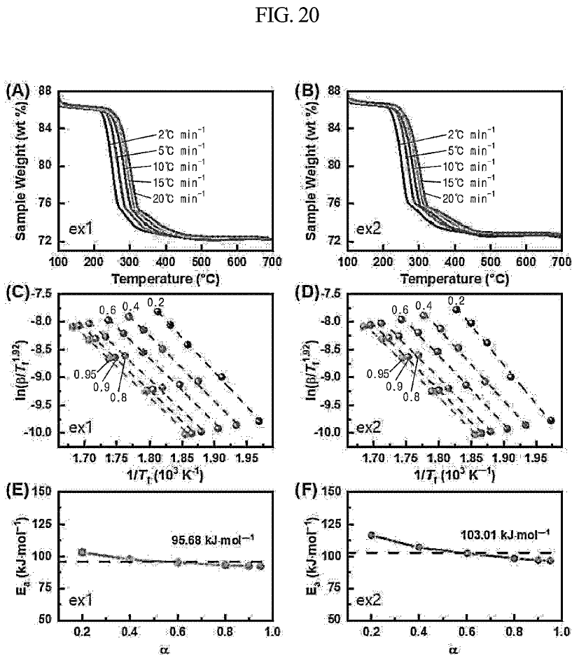

FIG. 20 is graphs for comparing activation energy in heat treatment processes of the cathode active material precursors according to Experimental Example 1 and Experimental Example 2 of the present invention.

Referring to FIGS. (A) of FIG. 20 to (D) of FIG. 20, in heat treatment processes of the cathode active material precursors according to Experimental Example 1 (ex1) and Experimental Example 2 (ex2), weight variations of the cathode active material precursors according to Experimental Example 1 (ex1) and Experimental Example 2 (ex2) were measured for each heating rate (2° Cmin⁻¹, 5° Cmin⁻¹, 10° Cmin⁻¹, 15° Cmin⁻¹, 20° Cmin⁻¹) by using non-isothermal TGA.

Referring to (E) of FIG. 20 and (F) of FIG. 20, activation energy was calculated in the heat treatment processes of the cathode active material precursors according to Experimental Example 1 (ex1) and Experimental Example 2 (ex2) by using non-isothermal TGA results measured in FIGS. (A) of FIG. 20 to (D) of FIG. 20, a Starink equation, and an Ozawa equation, and calculation results were shown in graphs.

As shown in FIGS. (A) of FIG. 20 to (D) of FIG. 20, it may be found that activation energy (103.01 kJmol⁻¹) of the cathode active material precursor according to Experimental Example 2 (ex2) is 7.7% higher than activation energy (95.68 KJmol⁻¹) of the cathode active material precursor according to Experimental Example 1 (ex1). This factor is interpreted as being due to the fact that the cathode active material precursor according to Experimental Example 1 (ex1) is prepared by using the vacuum oven, while the cathode active material precursor according to Experimental Example 2 (ex2) is prepared by using the convection oven. Accordingly, it may be found that Mn²⁺ is provided on the surface (shell) of the cathode active material precursor according to Experimental Example 1 (ex1), while Mn⁴⁺ as well as Mn²⁺ is provided on the surface (shell) of the cathode active material precursor according to Experimental Example 2 (ex2). In general, a diffusion energy barrier of Mn⁴⁺ is higher than a diffusion energy barrier of Mn²⁺. Therefore, it may be found that, in the heat treatment processes of the cathode active material precursors according to Experimental Example 1 (ex1) and Experimental Example 2 (ex2), the activation energy of the cathode active material precursor according to Experimental Example 2 (ex2) is higher than the activation energy of the cathode active material precursor according to Experimental Example 1 (ex1).

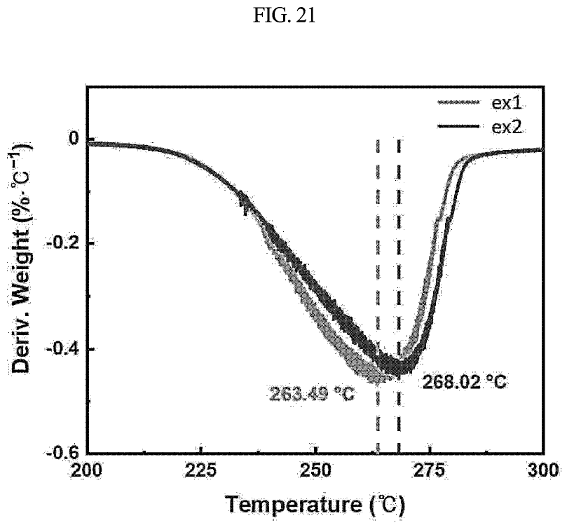

FIG. 21 is a graph for comparing derivation weight curves in the heat treatment processes of the cathode active material precursors according to Experimental Example 1 and Experimental Example 2 of the present invention.

Referring to FIG. 21, in the heat treatment processes of the cathode active material precursors according to Experimental Example 1 (ex1) and Experimental Example 2 (ex2), weight variations of the cathode active material precursors according to Experimental Example 1 (ex1) and Experimental Example 2 (ex2) were measured in a temperature range of 200° C. to 300° C., and measurement results were shown as derivation weight curves.

As shown in FIG. 21, it may be found that a temperature at which oxidation and dehydration of metal hydroxide of the cathode active material precursor according to Experimental Example 1 (ex1) occur is 263.49° C. In contrast, it may be found that a temperature at which oxidation and dehydration of metal hydroxide of the cathode active material precursor according to Experimental Example 2 (ex2) occur is 268.02° C. Accordingly, it may be found that energy for causing oxidation and dehydration of metal hydroxide of the cathode active material precursor according to Experimental Example 2 (ex2) is higher than energy for causing oxidation and dehydration of metal hydroxide of the cathode active material precursor according to Experimental Example 1 (ex1).

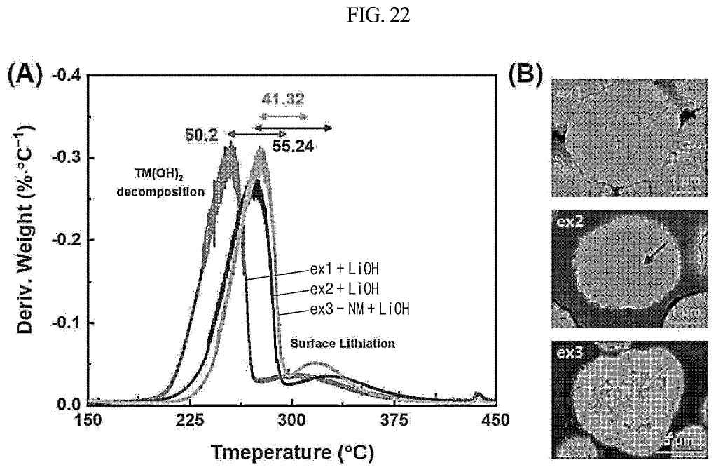

FIG. 22 is a graph for comparing DTA curves in heat treatment processes of the cathode active material precursors according to Experimental Example 1 to Experimental Example 3 of the present invention, and sections of the cathode active materials according to Experimental Example 1 to Experimental Example 3 generated after heat treatments have been performed.

Referring to (A) of FIG. 22, in heat treatment processes of the cathode active material precursors according to Experimental Example 1 (ex1) to Experimental Example 3 (ex3), weight variations of the cathode active material precursors according to Experimental Example 1 (ex1) to Experimental Example 3 (ex3) were measured in a temperature range of 150° C. to 450° C., and measurement results were shown as DTA curves. In addition, oxidation and decomposition reaction temperatures of metal hydroxide of the cathode active material precursors according to Experimental Example 1 (ex1) to Experimental Example 3 (ex3) occurring at 200° C. to 300° C. and surface lithiation reaction temperatures of the cathode active material precursors according to Experimental Example 1 (ex1) to Experimental Example 3 (ex3) occurring at 300° C. to 400° C. were recognized. Referring to FIG. 22(B), sections of the cathode active materials according to Experimental Example 1 (ex1) to Experimental Example 3 (ex3) generated after heat treatments of the cathode active material precursors according to Experimental Example 1 (ex1) to Experimental Example 3 (ex3) have been performed were photographed by an SEM.

As shown in (A) of FIG. 22, it may be found that a difference between the oxidation and decomposition reaction temperature of metal hydroxide and the surface lithiation reaction temperature is great in an order of the cathode active material precursor according to Experimental Example 3 (ex3) (41.32° C.), the cathode active material precursor according to Experimental Example 1 (ex1) (50.2° C.), and the cathode active material precursor according to Experimental Example 2 (ex2) (55.4° C.).

As shown in (B) of FIG. 22, the highest density may be found among a plurality of primary particles of the cathode active material according to Experimental Example 2 (ex2), and the least pores may be found among the primary particles of the cathode active material according to Experimental Example 2 (ex2). This factor is interpreted as being due to the fact that, in the heat treatment process of the cathode active material precursor according to Experimental Example 2 (ex2), competition between an oxidation and decomposition reaction of metal hydroxide of the cathode active material precursor according to Experimental Example 2 (ex2) and a surface lithiation reaction is reduced.

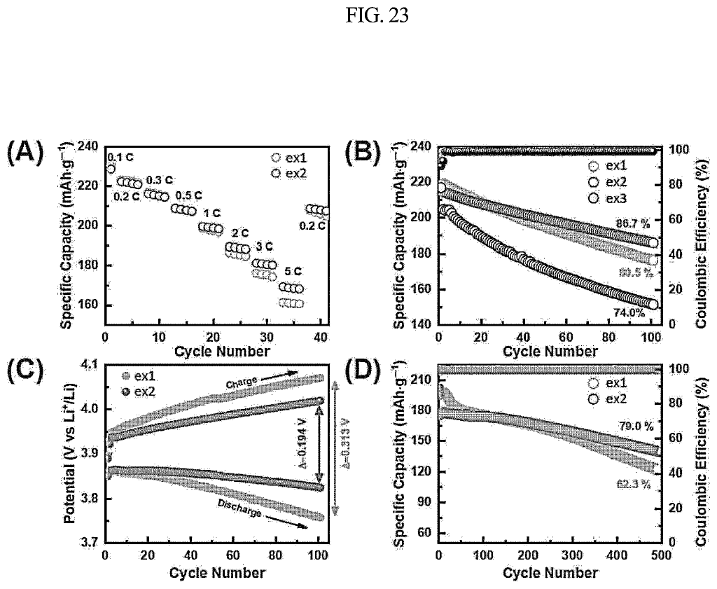

FIG. 23 is graphs for comparing performance of half-cells and full-cells to which the cathode active materials according to Experimental Example 1 to Experimental Example 3 of the present invention are applied.

Referring to (A) of FIG. 23, the cathode active materials according to Experimental Example 1 (ex1) and Experimental Example 2 (ex2) were applied to cathodes, respectively, and coin cells were inserted, so that half-cells according to Experimental Example 1 (ex 1) and Experimental Example 2 (ex2) were prepared. In addition, capacities of the half-cells according to Experimental Example 1 (ex1) and Experimental Example 2 (ex2) were measured for each C-rate (0.1 C, 0.2 C, 0.3 C, 0.5 C, 1 C, 2 C, 3 C, 5 C) and each charge/discharge cycle of the half-cells according to Experimental Example 1 (ex1) and Experimental Example 2 (ex2). Referring to (B) of FIG. 23, the cathode active material according to Experimental Example 3 (ex3) was applied to a cathode, and a coin cell was inserted, so that a half-cell according to Experimental Example 3 (ex3) was prepared. In addition, capacities of the half-cells according to Experimental Example 1 (ex1) to Experimental Example 3 (ex3) were measured while performing 100 charge/discharge cycles of the half-cells according to Experimental Example 1 (ex1) to Experimental Example 3 (ex3) under a condition of 0.5 C. Referring to (C) of FIG. 23, charge and discharge voltages of the half-cells according to Experimental Example 1 (ex1) and Experimental Example 2 (ex2) were measured while performing 100 charge/discharge cycles of the half-cells according to Experimental Example 1 (ex 1) and Experimental Example 2 (ex2) under a condition of 0.5 C. Referring to (D) of FIG. 23, the cathode active materials according to Experimental Example 1 (ex1) and

Experimental Example 2 (ex2) were applied to cathodes, respectively, and graphite was applied to an anode as an anode active material, so that full-cells according to Experimental Example 1 (ex1) and Experimental Example 2 (ex2) were prepared. In addition, capacities of the full-cells according to Experimental Example 1 (ex1) and Experimental Example 2 (ex2) were measured while performing 500 charge/discharge cycles of the full-cells according to Experimental Example 1 (ex1) and Experimental Example 2 (ex2).

As shown in (A) of FIG. 23, it may be found that the half-cells according to Experimental Example 1 (ex1) and Experimental Example 2 (ex2) have substantially similar capacities under a condition of 0.2 C to 0.5 C. Meanwhile, it may be found that the half-cell according to Experimental Example 2 (ex2) has a higher capacity than the half-cell according to Experimental Example 1 (ex 1) under a condition of 2 C or more. This factor is interpreted as being due to the fact that a crystal size (86.4 nm) of the cathode active material according to Experimental Example 2 (ex2) is smaller than a crystal size (94.6 nm) of the cathode active material according to Experimental Example 1 (ex1).

As shown in (B) of FIG. 23, it may be found that, after performing an initial cycle, cach of the capacities of the half-cells according to Experimental Example 1 (ex 1) and Experimental Example 2 (ex2) is 230 mAg-1 or more. In addition, it may be found that, after performing 100 charge/discharge cycles, a capacity retention rate (86.7%) of the half-cell according to Experimental Example 2 (ex2) is 6% to 7% higher than a capacity retention rate (80.5%) of the half-cell according to Experimental Example 1 (ex1). This factor is interpreted as being due to the fact that the core-shell structure of the cathode active material precursor according to Experimental Example 2 (ex2) is maintained even after the heat treatment due to oxidized Mn atoms on the surface (shell) of the cathode active material precursor.

As shown in (C) of FIG. 23, it may be found that, after performing 100 charge/discharge cycles of the half-cell according to Experimental Example 1 (ex1), a difference between charge and discharge potentials is 0.313 V. In contrast, it may be found that, after performing 100 charge/discharge cycles of the half-cell according to Experimental Example 2 (ex2), a difference between charge and discharge potentials is 0.194 V. Therefore, it may be found that, after performing 100 charge/discharge cycles, the difference between the charge and discharge potentials of the half-cell according to Experimental Example 2 (ex2) is smaller than the difference between the charge and discharge potentials of the half-cell according to Experimental Example 1 (ex1).

Referring to (D) of FIG. 23, it may be found that, after performing 500 charge/discharge cycles, a capacity retention rate (79.0%) of the full-cell according to Experimental Example 2 (ex2) is higher than a capacity retention rate (62.3%) of the full-cell according to Experimental Example (ex1). Therefore, it may be found that long-term stability for the charge/discharge cycles of the full-cell according to Experimental Example 2 (ex2) is superior to long-term stability for the charge/discharge cycles of the full-cell according to Experimental Example 1 (ex1).

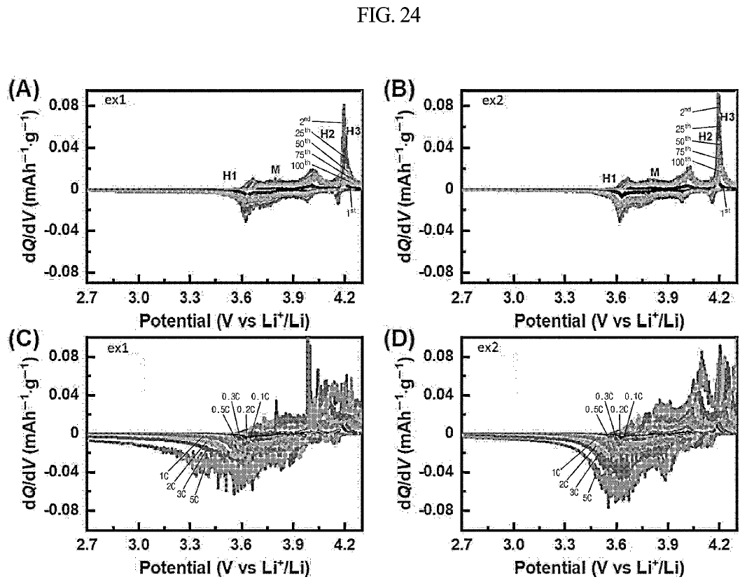

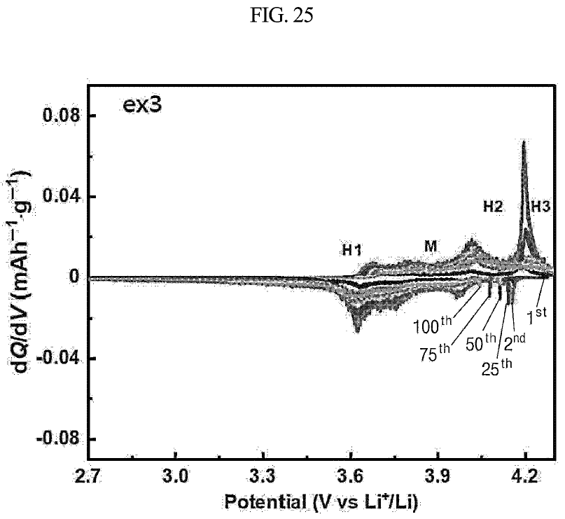

FIG. 24 is graphs for comparing differential capacities (dQ/dV) of the half-cells to which the cathode active materials according to Experimental Example 1 and Experimental Example 2 of the present invention are applied, and FIG. 25 is a graph obtained by measuring a differential capacity (dQ/dV) of the half-cell to which the cathode active material according to Experimental Example 3 of the present invention is applied.

Referring to (A) of FIG. 24, differential capacities of the half-cells according to Experimental Example 1 (ex1) and Experimental Example 2 (ex2) were measured according to the number of charge/discharge cycles (1^{st}, 2^{nd}, 24^{th}, 50^{th}, 75^{th}, 100^{th}) of the half-cells according to Experimental Example 1 (ex1) and Experimental Example 2 (ex2) described above in (A) of FIG. 23. Referring to (B) of FIG. 24, differential capacities of the half-cells according to Experimental Example 1 (ex1) and Experimental Example 2 (ex2) were measured according to the C-rate (0.1 C, 0.2 C, 0.3 C, 0.5 C, 1 C, 2 C, 3 C, 5 C) of the half-cells according to Experimental Example 1 (ex1) and Experimental Example 2 (ex2). Referring to FIG. 25, a differential capacity of the half-cell according to Experimental Example 3 (ex3) was measured according to the number of charge/discharge cycles (1^{st}, 2^{nd}, 24^{th}, 50^{th}, 75^{th}, 100^{th}) of the half-cell according to Experimental Example 3 (ex3) described above in (B) of FIG. 23.

As shown in FIGS. (A) of FIG. 24 to (D) of FIG. 24, it may be found that the cathode active materials of the cathodes of the half-cells according to Experimental Example 1 (ex1) and Experimental Example 2 (ex2) are subjected to phase transitions to H1, H2, and H3 in charge/discharge processes. It may be found in the cathode active material of the cathode of the half-cell according to Experimental Example 1 (ex 1) that, after performing 50 charge/discharge cycles, a peak subjected to a phase transition from H2 to H3 accompanied by variations in anisotropic lattice and volume is reduced. In contrast, it may be found in the cathode active material of the cathode of the half-cell according to Experimental Example 2 (ex2) that, even after performing 100 charge/discharge cycles, a peak subjected to a phase transition from H2 to H3 is clearly observed. In addition, it may be found that potential enhancement of the half-cell according to Experimental Example 2 (ex2) is lower than potential enhancement of the half-cell according to Experimental Example 1 (ex1). Accordingly, it may be found that stability for charge/discharge cycles and a capacity retention rate are higher in the half-cell according to Experimental Example 2 (ex2) than in the half-cell according to Experimental Example 1 (ex1). This factor is interpreted as being due to the fact that, in a process of preparing the cathode active material according to Experimental Example 2 (ex2), the preliminary cathode active material precursor according to Experimental Example 2 (ex2) is dried in the convection oven so as to oxidize manganese on the surface (shell) of the preliminary cathode active material precursor according to Experimental Example 2 (ex2), so that the cathode active material precursor including a core having a relatively high concentration of nickel and a shell surrounding the core and having a relatively high concentration of manganese according to Experimental Example 2 (ex2) is applied to the cathode.

As shown in FIG. 25, it may be found in the half-cell according to Experimental Example 3 (ex3) that, after 25 charge/discharge cycles, a peak subjected to a phase transition from H2 to H3 is reduced.

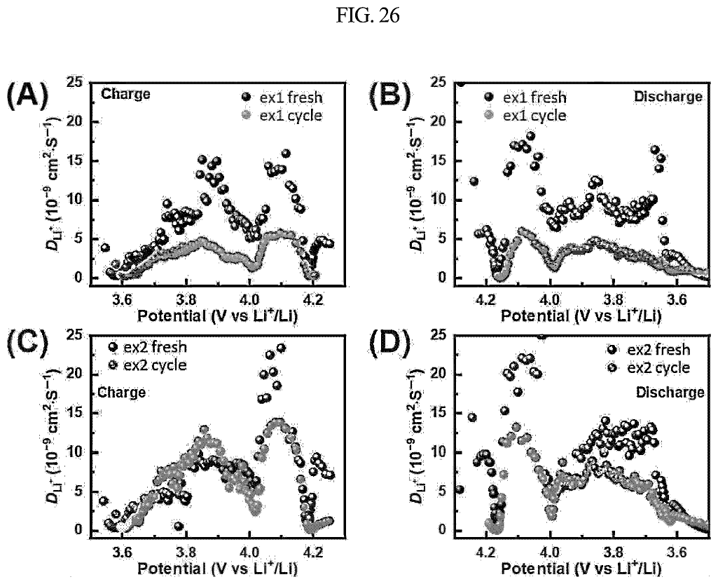

FIG. 26 is graphs for comparing diffusion coefficients of lithium ions in charge/discharge processes of the half-cells to which the cathode active materials according to Experimental Example 1 and Experimental Example 2 of the present invention are applied.

Referring to (A) of FIG. 26, in an initial state and a state after performing long-term charge/discharge cycles of the half-cell according to Experimental Example 1 (ex1) described above in (B) of FIG. 23, a lithium diffusion coefficient of the half-cell according to Experimental Example 1 (ex1) for charge was measured by a GITT. Referring to (B) of FIG. 26, in the initial state and the state after performing the long-term charge/discharge cycles of the half-cell according to Experimental Example 1 (ex1), a lithium diffusion coefficient of the half-cell according to Experimental Example 1 (ex1) for discharge was measured by a GITT. Referring to (C) of FIG. 26, in an initial state and a state after performing long-term charge/discharge cycles of the half-cell according to Experimental Example 2 (ex2) described above in (B) of FIG. 23, a lithium diffusion coefficient of the half-cell according to Experimental Example 2 (ex2) for charge was measured by a GITT. Referring to (D) of FIG. 26, in the initial state and the state after performing the long-term charge/discharge cycles of the half-cell according to Experimental Example 2 (ex2), a lithium diffusion coefficient of the half-cell according to Experimental Example 2 (ex2) for discharge was measured by a GITT.

As shown in FIGS. (A) of FIG. 26 to (D) of FIG. 26, it may be found that, in the initial states of the half-cells according to Experimental Example 1 (ex 1) and Experimental Example 2 (ex2), the lithium diffusion coefficients of the half-cells according to Experimental Example 1 (ex1) and Experimental Example 2 (ex2) for the charge and the discharge are substantially similar to each other. In contrast, it may be found that, in the states after performing the long-term charge/discharge cycles of the half-cells according to Experimental Example 1 (ex1) and Experimental Example 2 (ex2), the lithium diffusion coefficients of the half-cell according to Experimental Example 2 (ex2) are higher than the lithium diffusion coefficients of the half-cell according to Experimental Example 1 (ex1) for the charge and the discharge, respectively. This factor is interpreted as being due to the fact that, in the charge/discharge cycles of the half-cell according to Experimental Example 2 (ex2), a side reaction occurring at an interface between an electrolyte and the cathode of the half-cell according to Experimental Example 2 (ex2) is minimized, and generation of by-products is minimized on the interface, so that diffusion of lithium ions into the interface is facilitated.

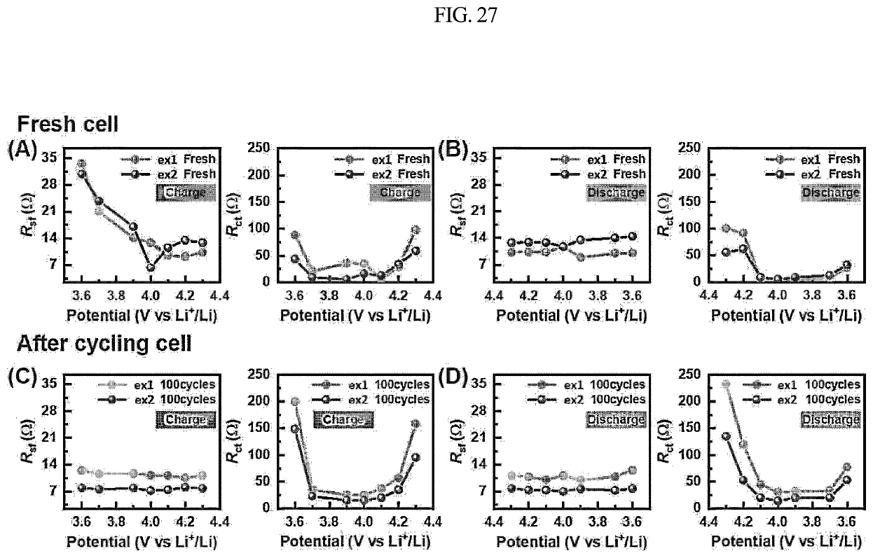

FIG. 27 is graphs for comparing resistance values of the half-cells to which the cathode active materials according to Experimental Example 1 and Experimental Example 2 of the present invention are applied.

Referring to (A) of FIG. 27, in the initial states of the half-cells according to Experimental Example 1 (ex 1) and Experimental Example 2 (ex2) described above in (A) of FIG. 25, a R_{sf} value, which is a resistance of the interface between the cathode and the electrolyte, and a R_{ct} value, which is a charge transfer resistance between the cathode active material and the electrolyte, for the charge were measured. Referring to (B) of FIG. 27, in the initial states of the half-cells according to Experimental Example 1 (ex 1) and Experimental Example 2 (ex2), an R_{sf} value and an R_{ct} value for the discharge of the half-cells according to Experimental Example 1 (ex 1) and Experimental Example 2 (ex2) were measured. Referring to (C) of FIG. 27, in states after performing 100 charge/discharge cycles of the half-cells according to Experimental Example 1 (ex1) and Experimental Example 2 (ex2), an R_{sf} value and an R_{ct} value for the charge of the half-cells according to Experimental Example 1 (ex1) and Experimental Example 2 (ex2) were measured. Referring to (D) of FIG. 27, in the states after performing the 100 charge/discharge cycles of the half-cells according to Experimental Example 1 (ex1) and Experimental Example 2 (ex2), a R_{sf} value and a R_{ct} value for the discharge of the half-cells according to Experimental Example 1 (ex1) and Experimental Example 2 (ex2) were measured.

As shown in (A) of FIG. 27 and (B) of FIG. 27, it may be found that, in the initial states of the half-cells according to Experimental Example 1 (ex 1) and Experimental Example 2 (ex2), the R_{sf} values and the Rut values for the charge and the discharge of the half-cell according to Experimental Example 1 (ex 1) are substantially similar to the R_{sf} values and the R_{ct} values for the charge and the discharge of the half-cell according to Experimental Example 2 (ex2), respectively.

As shown in (C) of FIG. 27 and (D) of FIG. 27, it may be found that, in the states after performing the 100 charge/discharge cycles of the half-cells according to Experimental Example 1 (ex1) and Experimental Example 2 (ex2), the R_{sf} values and the Rut values for the charge and the discharge of the half-cell according to Experimental Example 2 (ex2) are lower than the R_{sf} values and the R_{ct} values for the charge and the discharge of the half-cell according to Experimental Example 1 (ex1), respectively. This factor is interpreted as being due to the fact that, in a charge/discharge cycle process, a structure of the shell of the cathode active material according to Experimental Example 2 (ex2) is stably maintained in the core-shell structure of the cathode active material within the cathode of the half-cell according to Experimental Example 2 (ex2), so that the cathode active material is protected from the electrolyte.

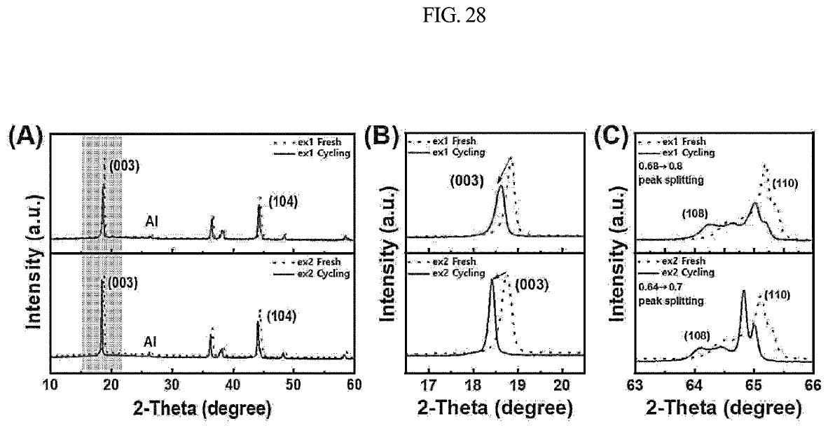

FIG. 28 is graphs for comparing crystal structures of the half-cells to which the cathode active materials according to Experimental Example 1 and Experimental Example 2 of the present invention are applied before/after charge/discharge cycles.

Referring to (A) of FIG. 28, before performing charge/discharge cycles of the half-cells according to Experimental Example 1 (ex1) and Experimental Example 2 (ex2) described above in (A) of FIG. 23, the cathodes of the half-cells according to Experimental Example 1 (ex1) and Experimental Example 2 (ex2) were analyzed by XRD, and, after performing 100 charge/discharge cycles of the half-cells according to Experimental Example 1 (ex 1) and Experimental Example 2 (ex2), the cathodes of the half-cells according to Experimental Example 1 (ex1) and Experimental Example 2 (ex2) were analyzed by XRD. Referring to (B) of FIG. 28, a graph in which a peak associated with a (003) plane associated with cation mixing and a rock-salt transition is enlarged in the graph analyzed by XRD in (A) of FIG. 28 is shown. Referring to (C) of FIG. 28, a graph in which split peaks of (108) and (110) planes associated with lithium consumption caused by a side reaction is enlarged in the graph analyzed by XRD in (A) of FIG. 28 is shown.

As shown in (A) of FIG. 28 and (B) of FIG. 28, it may be found that a peak intensity of a (003) plane of the cathode of the half-cell according to Experimental Example 1 (ex1) after the 100 charge/discharge cycles is weaker than a peak intensity of a (003) plane of the cathode of the half-cell according to Experimental Example 1 (ex 1) before the 100 charge/discharge cycles. In contrast, it may be found that a peak intensity of a (003) plane of the cathode of the half-cell according to Experimental Example 2 (ex2) after the 100 charge/discharge cycles and a peak intensity of a (003) plane of the cathode of the half-cell according to Experimental Example 2 (ex2) before the 100 charge/discharge cycles are substantially similar to each other.

As shown in (C) of FIG. 28, it may be found that split peaks of a (108) plane and a (100) plane of the cathode of the half-cell according to Experimental Example 1 (ex1) after the 100 charge/discharge cycles is about 0.12 lower than split peaks of a (108) plane and a (100) plane of the cathode of the half-cell according to Experimental Example 1 (ex1) before the 100 charge/discharge cycles. In contrast, it may be found that split peaks of a (108) plane and a (100) plane of the cathode of the half-cell according to Experimental Example 2 (ex2) after the 100 charge/discharge cycles is about 0.06 lower than split peaks of a (108) plane and a (100) plane of the cathode of the half-cell according to Experimental Example 2 (ex2) before the 100 charge/discharge cycles. Therefore, it may be found that, in the charge/discharge cycle process, the side reaction between the cathode and the electrolyte is suppressed more so that the loss of lithium ions is reduced more in the cathode of the half-cell according to Experimental Example 2 (ex2) than in the cathode of the half-cell according to Experimental Example 1 (ex1).

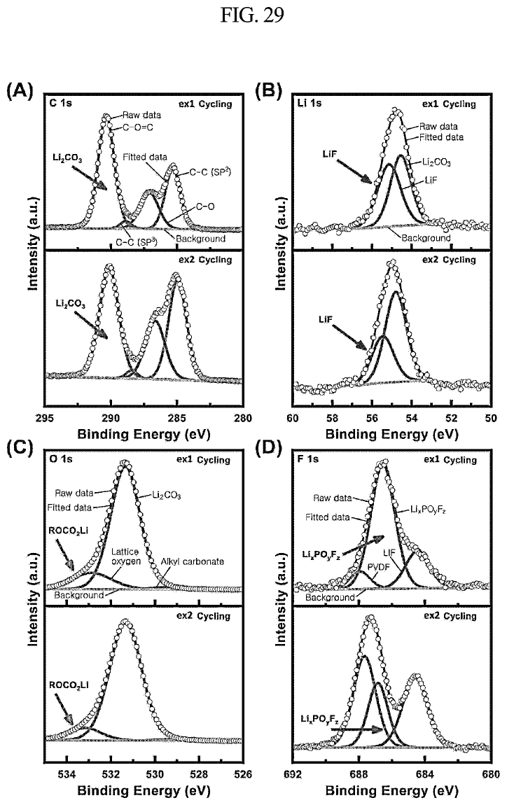

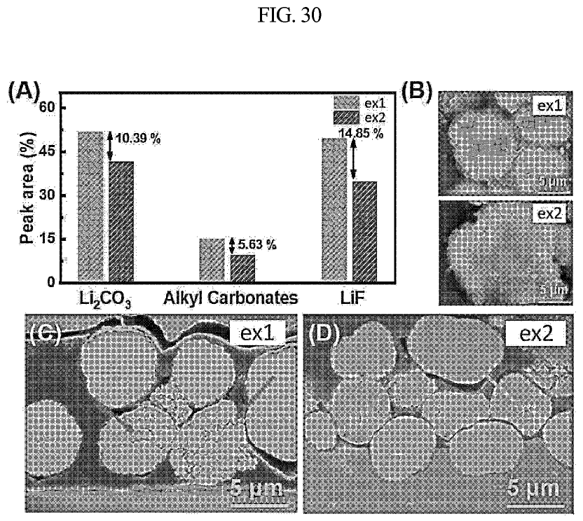

FIGS. 29 and 30 are graphs for comparing amounts of by-products of the half-cells to which the cathode active materials according to Experimental Example 1 and Experimental Example 2 of the present invention are applied, which are generated after the charge/discharge cycles.

Referring to (A) of FIG. 29, after performing 100 charge/discharge cycles of the half-cells according to Experimental Example 1 (ex1) and Experimental Example 2 (ex2) described above in (B) of FIG. 23, C 1 s spectra of the cathodes of the half-cells according to Experimental Example 1 (ex1) and Experimental Example 2 (ex2) were analyzed by XPS. Referring to (B) of FIG. 29, after performing 100 charge/discharge cycles of the half-cells according to Experimental Example 1 (ex1) and Experimental Example 2 (ex2), Li 1 s spectra of the cathodes of the half-cells according to Experimental Example 1 (ex1) and Experimental Example 2 (ex2) were analyzed by XPS. Referring to (C) of FIG. 29, after performing 100 charge/discharge cycles of the half-cells according to Experimental Example 1 (ex1) and Experimental Example 2 (ex2), O 1 s spectra of the cathodes of the half-cells according to Experimental Example 1 (ex1) and Experimental Example 2 (ex2) were analyzed by XPS. Referring to (D) of FIG. 29, after performing 100 charge/discharge cycles of the half-cells according to Experimental Example 1 (ex1) and Experimental Example 2 (ex2), F 1 s spectra of the cathodes of the half-cells according to Experimental Example 1 (ex1) and Experimental Example 2 (ex2) were analyzed by XPS. Referring to (A) of FIG. 30, in the XPS graphs analyzed in FIGS. (A) of FIG. 29 to (D) of FIG. 29, peaks corresponding to Li₂CO₃, alkyl carbonate, and LiF generated by decomposition of the electrolyte and salt at the interface between the cathode and the electrolyte were expressed in quantitative numerical values. Referring to (B) of FIG. 30, after performing 100 charge/discharge cycles of the half-cells according to Experimental Example 1 (ex1) and Experimental Example 2 (ex2), the cathodes of the half-cells according to Experimental Example 1 (ex1) and Experimental Example 2 (ex2) were photographed by an SEM. Referring to (C) of FIG. 30 and (D) of FIG. 30, sections of the cathodes of the half-cells according to Experimental Example 1 (ex1) and Experimental Example 2 (ex2) were photographed by an SEM.

As shown in FIGS. (A) of FIG. 29 to (D) of FIG. 29, it may be found that, at the interface between the electrolyte and the cathode of each of the half-cells according to Experimental Example 1 (ex1) and Experimental Example 2 (ex2), Li₂CO₃ is generated at 290.38 eV in the C 1 s spectrum, alkyl carbonate is generated at 532.9 eV in the O 1 s spectrum, LiF is generated at 55.2 eV in the Li 1 s spectrum, and LiₓPO_{y}F_{z} is generated at 686.6 eV in the F 1 s spectrum.

As shown in FIGS. (A) of FIG. 30 to (C) of FIG. 30, it may be found that Li₂CO₃, alkyl carbonate, and LiF generated at the interface between the electrolyte and the cathode of the half-cell according to Experimental Example 2 (ex2) are less than Li₂CO₃, alkyl carbonate, and LiF generated at the interface between the electrolyte and the cathode of the half-cell according to Experimental Example 1 (ex1). Accordingly, it may be found that a thickness of the interface on the cathode of the half-cell according to Experimental Example 2 (ex2) is thinner than a thickness of the interface on the cathode of the half-cell according to Experimental Example 1 (ex1). In addition, it may be found that, after performing the 100 charge/discharge cycles, crack damage generated in the cathode active material of the cathode of the half-cell according to Experimental Example 2 (ex2) is less than crack damage generated in the cathode active material of the cathode of the half-cell according to Experimental Example 1 (ex1). Accordingly, it may be found that a side reaction between the electrolyte and the cathode active material of the cathode of the half-cell according to Experimental Example 2 (ex2) is reduced more as compared to a side reaction between the electrolyte and the cathode active material of the cathode of the half-cell according to Experimental Example 1 (ex1).

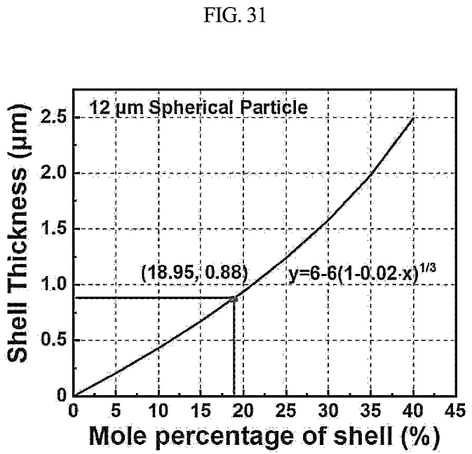

FIG. 31 is a graph obtained by analyzing chemical compositions of the cathode active material precursor and the cathode active material according to Experimental Example 2 of the present invention.

Referring to FIG. 31, chemical compositions of the cathode active material precursor and the cathode active material according to Experimental Example 2 (ex2) were analyzed by ICP-OES, and relation between the thickness of the shell and a mole proportion of the shell of the cathode active material according to Experimental Example 2 (ex2) was expressed as a mathematical formula on the graph.

As shown in FIG. 31, it may be found that the chemical composition of the cathode active material precursor according to Experimental Example 2 (ex2) measured by using ICP-OES is Ni_{0.97}Mn_{0.03}(OH)₂, and the chemical composition of the cathode active material according to Experimental Example 2 (ex2) measured by using ICP-OES is Li_{1.03}Ni_{0.97}Mn_{0.03}O₂. In addition, it may be found that a Mn content of the shell of the cathode active material according to Experimental Example 2 (ex2) theoretically calculated by using the mathematical formula is 3% to 4%. Therefore, it may be found that a Mn content of the shell of the cathode active material according to Experimental Example 2 (ex2) measured by using ICP-OES and the Mn content of the shell of the cathode active material according to Experimental Example 2 (ex2) theoretically calculated by using the mathematical formula are consistent with each other.

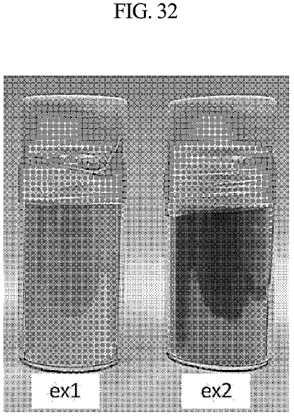

FIG. 32 is an actual photograph of the cathode active material precursors according to Experimental Example 1 and Experimental Example 2 of the present invention.

Referring to FIG. 32, actual photographs were taken immediately after the cathode active material precursors according to Experimental Example 1 (ex1) and Experimental Example 2 (ex2) are prepared.

As shown in FIG. 32, it may be found that the cathode active material precursor according to Experimental Example 1 (ex1) is dark green. In contrast, it may be found that the cathode active material precursor according to Experimental Example 2 (ex2) is dark brown. This factor is interpreted as being due to the fact that, in the process of preparing the cathode active material precursor according to Experimental Example 2 (ex2), the preliminary cathode active material precursor according to Experimental Example 2 (ex2) is introduced into the convection oven so as to be dried. Accordingly, it may be found that Mn on the surface (shell) of the preliminary cathode active material according to Experimental Example 2 (ex2) is oxidized, so that the cathode active material precursor according to Experimental Example 2 (ex2) is dark brown.

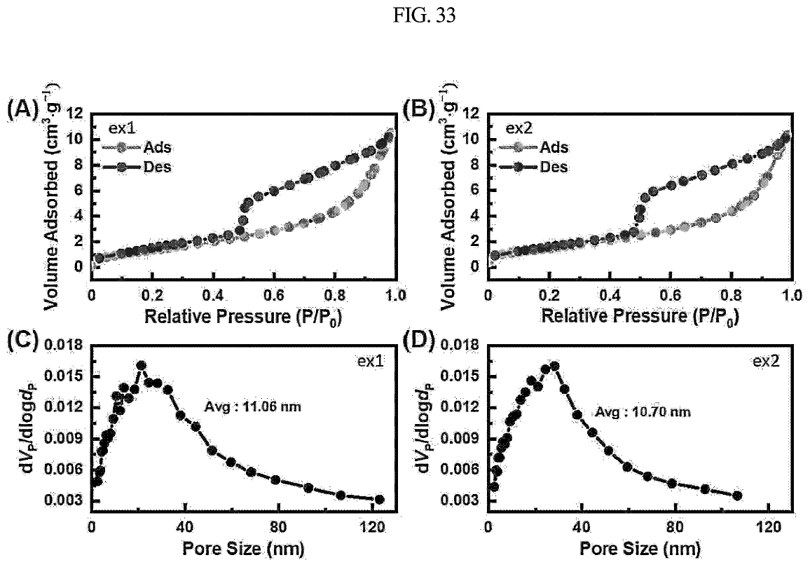

FIG. 33 is graphs for comparing surface areas and pore sizes of the cathode active materials according to Experimental Example 1 and Experimental Example 2 of the present invention.

Referring to (A) of FIG. 33, an adsorption and desorption degree of nitrogen of the cathode active material according to Experimental Example 1 (ex 1) was calculated by a Brunauer-Emmett-Teller (BET) scheme, and a surface area of the cathode active material according to Experimental Example 1 (ex1) was shown in a graph. Referring to (B) of FIG. 33, an adsorption and desorption degree of nitrogen of the cathode active material according to Experimental Example 2 (ex2) was calculated by a Brunauer-Emmett-Teller (BET) scheme, and a surface area of the cathode active material according to Experimental Example 2 (ex2) was shown in a graph. Referring to (C) of FIG. 33, an adsorption and desorption degree of nitrogen of the cathode active material according to Experimental Example 1 (ex1) was calculated by a Barrett-Joyner-Halenda (BJH) scheme, and a pore size of the cathode active material according to Experimental Example 1 (ex1) was shown in a graph. Referring to (D) of FIG. 33, an adsorption and desorption degree of nitrogen of the cathode active material according to Experimental Example 2 (ex2) was calculated by a Barrett-Joyner-Halenda (BJH) scheme, and a pore size of the cathode active material according to Experimental Example 2 (ex2) was shown in a graph.

As shown in FIGS. (A) of FIG. 33 to (D) of FIG. 33, it may be found that the surface areas and average pore sizes of the cathode active materials according to Experimental Example 1 (ex1) and Experimental Example 2 (ex2) are substantially at similar levels.

Although the exemplary embodiments of the present invention have been described in detail above, the scope of the present invention is not limited to a specific embodiment, and shall be interpreted by the appended claims. In addition, it is to be understood by a person having ordinary skill in the art that various changes and modifications can be made without departing from the scope of the present invention.

### INDUSTRIAL APPLICABILITY

A cathode active material according to an embodiment of the present invention may be used in various devices such as lithium secondary batteries, electric vehicles, mobile devices, and ESS.

What is claimed is:

1. A method for preparing a cathode active material, the method comprising:
preparing a precursor solution, a chelating agent, and a pH adjuster,
preparing a preliminary cathode active material precursor by introducing the precursor solution, the chelating agent, and the pH adjuster into a reactor, and
preparing a cathode active material precursor by oxidizing a surface of the preliminary cathode active material precursor.

2. The method of claim 1, wherein the precursor solution includes a core precursor solution including a first transition metal, and a shell precursor solution including the first transition metal and a second transition metal.

3. The method of claim 2, wherein the preparing of the preliminary cathode active material precursor includes:
preparing a core by introducing the core precursor solution into the reactor and coprecipitating the core precursor solution; and
preparing the preliminary cathode active material precursor having a shell surrounding the core by introducing the shell precursor solution in the core into the reactor and coprecipitating the shell precursor solution.

4. The method of claim 3, wherein the preparing of the cathode active material precursor by oxidizing the surface of the preliminary cathode active material precursor includes:
introducing the preliminary cathode active material precursor into a convection oven, and oxidizing the surface of the preliminary cathode active material precursor by using convection of air generated in the convection oven.

5. The method of claim 4, wherein the preliminary cathode active material precursor includes hydroxide including the first transition metal and the second transition metal, and
the cathode active material precursor obtained by oxidizing the surface of the preliminary cathode active material precursor includes oxyhydroxide including the first transition metal and the second transition metal.

6. The method of claim 5, wherein the first transition metal includes Ni,
the second transition metal includes Mn,
the preliminary cathode active material precursor includes NiMn(OH)₂, and
the cathode active material precursor includes NiMnOOH.

7. The method of claim 6, wherein the preparing of the cathode active material precursor by oxidizing the surface of the preliminary cathode active material precursor includes:
increasing an oxidation number of Mn on the surface of the preliminary cathode active material precursor to +2 or more, or to +4

8. The method of claim 7, wherein Mn having an oxidation number of +2 is provided on the surface of the preliminary cathode active material precursor, and
Mn having an oxidation number of +4 is provided on a surface of the cathode active material precursor.

9. The method of claim 8, wherein the cathode active material precursor includes a core and a shell surrounding the core, in which a concentration of Ni is higher than a concentration of Mn in the core, and a concentration of Mn is higher than a concentration of Ni in the shell, and
the preparing of the cathode active material by heat-treating the cathode active material precursor includes:
preventing Mn of the shell from being diffused into the core by Mn⁴⁺ of the shell of the cathode active material precursor.

10. A cathode active material precursor including a core and a shell surrounding the core, wherein a concentration of a first transition metal is higher than a concentration of a second transition metal in the core,
a concentration of the second transition metal is higher than a concentration of the first transition metal in the shell, and
the shell includes oxyhydroxide including the first transition metal and the second transition metal.

11. The cathode active material precursor of claim 10, wherein the first transition metal includes Ni,
the second transition metal includes Mn, and
Mn⁴⁺ is observed at 595 cm⁻¹ when the cathode active material precursor is analyzed by Raman spectroscopy.

12. The cathode active material precursor of claim 11, wherein, when XPS analysis is performed on the cathode active material precursor, a proportion of Mn⁴⁺ is increased in a Mn 2P spectrum.

13. The cathode active material precursor of claim 12, wherein the proportion of Mn⁴⁺ of the cathode active material precursor is 25%.

14. A cathode active material including secondary particles obtained by allowing a plurality of primary particles to agglomerate, wherein the cathode active material includes a transition metal layer and a lithium layer, which are alternately and repeatedly stacked, and
Ni²⁺ is mixed in the lithium layer, in which a proportion of Ni²⁺ in the lithium layer exceeds 2.1% when XRD analysis is performed.

15. The cathode active material of claim 14, wherein, when XRD measurement is performed on the cathode active material, I₀₀₃/I₁₀₄, which is a proportion of a peak value Los corresponding to a (003) plane to a peak value 1104 corresponding to a (104) plane, is 1.32.

16. The cathode active material of claim 14, wherein, when XPS analysis is performed on the cathode active material, Ni^{2+/}(Ni²⁺+Ni³⁺), which is a peak devolution value of Ni³⁺ corresponding to a peak generated at 855.1 eV and Ni²⁺ corresponding to a peak generated at 853.8 eV, is 19.7%.
